(19) United States
(12) Patent Application Publication
(10) Pub. No.: US 2022/0170880 A1
(43) Pub. Date: Jun. 2, 2022

(54) METHOD OF CONDITIONING AN ION-SELECTIVE ELECTRODE

(71) Applicant: Kalium Health Ltd, Girton (GB)

(72) Inventors: Tanya HUTTER, Girton (GB); Elizabeth Emma NEILL, Girton (GB); Grzegorz Artur ORLOWSKI, Girton (GB)

(21) Appl. No.: 17/593,641

(22) PCT Filed: Mar. 25, 2020
(86) PCT No.: PCT/GB2020/050797

§ 371 Date: Sep. 22, 2021

(30) Foreign Application Priority Data
Mar. 26, 2019 (GB) 1904137.5

(51) Int. Cl. G01N 27/333

(52) U.S. Cl. CPC G01N 27/333

(57) ABSTRACT

A method of preparing/pre-conditioning/conditioning/treating an ion-selective electrode, ISE, for an ion-selective electrode cell, is described. The ion-selective electrode cell comprises the ISE and a reference electrode, RE. The method comprises exposing the ISE and a second electrode to a solution including the ion, applying a first potential difference, PD, of a first set of PDs, having a polarity, across the ISE and the second electrode and applying a first potential difference, PD, of a second set of PDs, having a reverse polarity, across the ISE and the second electrode.

### FIELD

The present invention relates to ion-selective electrodes for ion selective electrode cells. Particularly, the present invention relates to preparing ion-selective electrodes for ion selective electrode cells, for determining a presence of ions in solutions using the prepared ion-selective electrodes.

### BACKGROUND TO THE INVENTION

Generally, ion selective electrodes (ISEs) (also known as specific ion electrodes, SIEs), are transducers (also known as sensors) that convert ionic activities of selected ions in solutions into electrical responses, for example electrical potentials, currents and/or impedances. ISEs are used in ion-selective electrode cells, which include the ISEs in conjunction with reference electrodes. Concentrations of the selected ions in the solutions may be thus determined from the measured electrical responses, referenced to the reference electrodes. ISEs are used in analytical chemistry, environmental chemistry, food research, biomedical protocols and biochemical/biophysical research, typically for measurements of ionic concentrations in aqueous solutions.

Preferably, ISEs have rapid response times, such that steady or stable states are achieved quickly for measurements, are accurate and do not require calibration, thereby simplifying analytical protocols. Particularly, for point of care (POC) applications and consumer products, for example, it is important to complete measurements quickly, to provide rapid results. Steady or stable states allow for more accurate measurements as time-dependent electrical responses may be averaged over a few seconds to reduce system noise, for example. However, if baselines are not stable and/or change overtime, then measurement accuracies are degraded. In order to improve response times and/or baseline stabilities, ISEs conventionally require conditioning before use. Generally, conditioning involves exposing the ISEs to high concentrations of the specific ions, in a process that can take from 12 to 72 hours.

For healthcare applications, for example biological fluid such as blood analysis, relatively slow response times may be accompanied by property changes of the biological fluid during measurement. For example, blood may at least begin to dry and clot during a typical 120 s required to achieve a steady or stable state for measurement. This is particularly important when determining a concentration of potassium (K⁺) in whole blood samples, because of ongoing metabolic activity of red cells or platelet activation during clotting, both of which alter potassium levels.

Hence, there is a need to improve ISEs.

### SUMMARY OF THE INVENTION

It is one aim of the present invention, amongst others, to provide an ion-selective electrode cell and a method of preparing an ion-selective electrode, ISE, for an ion-selective electrode cell which at least partially obviates or mitigates at least some of the disadvantages of the prior art, whether identified herein or elsewhere. For instance, it is an aim of embodiments of the invention to provide an ion-selective electrode cell having a faster response time, accuracy, precision and/or reproducibility. For instance, it is an aim of embodiments of the invention to provide a method of preparing an ion-selective electrode, ISE, for an ion-selective electrode cell that reduces manufacturing complexity and/or time and/or may be performed in situ.

A first aspect provides a method of preparing an ion-selective electrode, ISE, for an ion-selective electrode cell, the ion-selective electrode cell comprising the ISE and a reference electrode, RE, the method comprising steps of:

exposing the ISE and a second electrode to a solution including the ion;

applying a first potential difference, PD, of a first set of PDs, having a polarity, across the ISE and the second electrode; and

applying a first potential difference, PD, of a second set of PDs, having a reverse polarity, across the ISE and the second electrode.

A second aspect provides a method of determining a presence of an ion in a solution using an ion-selective electrode cell comprising an ion-selective electrode, ISE, and a reference electrode, RE, the method comprising steps of:

preparing the ISE according to the first aspect using the solution; and

determining the presence of the ion in the solution, for example potentiometrically, galvanometrically and/or by impedance, using the ion-selective electrode cell including the prepared ISE, preferably within 300 s of completing the step of preparing of the ISE.

A third aspect provides an ion-selective electrode, ISE, prepared according to the first aspect.

A fourth aspect provides an ion selective electrode cell, comprising an ion-selective electrode, ISE, according to the third aspect and a reference electrode, RE.

A fifth aspect provides a device for preparing an ion-selective electrode, ISE, for an ion-selective electrode cell, the ion-selective electrode cell comprising the ISE and a reference electrode, RE, wherein the device is configured to:

apply a first potential difference, PD, of a first set of PDs, having a polarity, across the ISE and a second electrode; and

apply a first potential difference, PD, of a second set of PDs, having a reverse polarity, across the ISE and the second electrode.

A sixth aspect provides an ion-selective electrode cell assembly, or a kit for an ion-selective electrode cell assembly, comprising:

an ion-selective electrode cell comprising an ion-selective electrode, ISE, and a reference electrode, RE; and

a device according to the fifth aspect.

A seventh aspect provides use of in situ reversed polarities to condition an ion-selective electrode, ISE.

### DETAILED DESCRIPTION OF THE INVENTION

According to the present invention there is provided a method of preparing an ion-selective electrode, ISE, for an ion-selective electrode cell, as set forth in the appended claims. Also provided is a method of determining a presence of an ion in a solution, an ion-selective electrode cell, a device for preparing an ion-selective electrode, ISE, for an ion-selective electrode cell, an ion-selective electrode cell assembly, a kit for an ion-selective electrode cell assembly and use of in situ reversed polarities to condition a ISE. Other features of the invention will be apparent from the dependent claims, and the description that follows.

### Method of Preparing an Ion-Selective Electrode, ISE, for an Ion-Selective Electrode Cell

The first aspect provides a method of preparing an ion-selective electrode, ISE, for an ion-selective electrode cell, the ion-selective electrode cell comprising the ISE and a reference electrode, RE, the method comprising steps of:

exposing the ISE and a second electrode to a solution including the ion;

applying a first potential difference, PD, of a first set of PDs, having a polarity, across the ISE and the second electrode; and

applying a first potential difference, PD, of a second set of PDs, having a reverse polarity, across the ISE and the second electrode.

In this way, a response time of the ion-selective electrode cell including the prepared ISE is improved, for example reduced, compared with conventional conditioning ISEs, as described previously and as detailed further below, while also eliminating the conventional conditioning. It should be understood that the response time is the time before a measurement using the ion-selective electrode cell may be measured, such as when a stable or steady signal is obtainable or obtained, for example a potentiometric, a galvanometric and/or an impedance measurement related to a concentration of the ion in the solution. That is, the method involves applying voltage pulses (i.e. the first PD and the second PD having the reversed polarity) on the ISE, typically for a short duration such as for a few seconds, just before the ion concentration is measured. This allows the ISE to reach steady-state, electrical equilibrium and electrode surface wetting almost instantly, resulting in steady signal within seconds and improved sensor linearity over a clinically-relevant range.

By eliminating the conventional conditioning, as-manufactured (i.e. dry) ion-selective electrode cells including as-manufactured ISEs may be rapidly prepared for measurement (i.e. a determination of a presence of the ion). This simplifies analytical protocols for ion-selective electrode cells, enabling these analytical protocols to be more readily and/or widely deployed, for example for POC or in-field applications. Manufacturing cost and/or complexity of the ion-selective electrode cells may be reduced since robustness to extended soaking may not be required, allowing selection of more cost-effective but less resistant substrates for the ion-selective electrode cells, for example. Additionally, pre-conditioned (i.e. pre-soaked) ion-selective electrode cells, having relatively short shelf lives (i.e. best before dates), are avoided. By improving response times of thus ion-selective electrode cells including the prepared ISEs, quantitative and/or qualitative determinations of a presence of ions in solution may be performed more quickly, allowing greater efficiencies and/or throughputs while providing more responsive results. This is important for time-critical or time-sensitive samples to be analysed, such as when monitoring a reaction or when on-going reactions increasingly inhibit or interfere with analysis as time progresses. For example, coagulation and/or drying of blood inhibits or interferes with analysis of ions of interest therein.

Further, an accuracy, a precision and/or a reproducibility of the measurement (i.e. a determination of a presence of the ion) may be improved, compared with conventional methods of conditioning ion-selective electrode cells, as described previously. Particularly, the method of preparing the ion-selective electrode cell, according to the first aspect, enhances a Nernstian response of and/or improves a linearity of the ISE. In addition, since the response time of the ion-selective electrode cell including the prepared ISE is improved, more measurements may be made while the signal is stable, thus improving a relative standard deviation (RSD) of the measurements, for example.

Furthermore, the method of preparing the ion-selective electrode cell, according to the first aspect, may be performed in situ. That is, the ion-selective electrode cell may be prepared using a sample to be analysed, wherein the sample to be analysed provides the solution including the ion, such that preparing the ISE therein and measuring the ion therein using the ion-selective electrode cell are performed using the same solution. Thus, for example, preparing and measuring may be performed successively. For example, the ion-selective electrode cell may be immersed into the sample to be analysed, such as a liquid, a suspension, a slurry or wetted particles, the ion-selective electrode cell prepared therein and a presence of the ion in the sample subsequently determined. For example, an amount of the sample to be analysed may be deposited on the ion-selective electrode cell, the ion-selective electrode cell prepared therewith and the presence of the ion in the sample subsequently determined. By way of example, for the analysis of K+ in a blood sample, the ion-selective electrode cell may be prepared, according to the method of the first aspect, using the blood and a presence of the K+ in the blood subsequently, for example immediately, determined. In this way, analysis of K+ in the blood sample is simplified, such that this analysis may be conducted at POC, for example by a patient.

In addition, since reversed polarity potential differences are applied across the ISE and the second electrode, concentration polarization of the ion, for example at a solution-membrane interface, is reduced. Particularly, if the reversed polarity potential differences are of equal magnitude and/or duration, low or no concentration polarization of the ion is expected.

It should be understood that by applying a potential difference, such as the first PD of the first set of PDs and/or the first PD of the second set of PDs, across the ISE and the second electrode, a current is provided, for example induced, therebetween, having a direction according to the polarity of the applied potential difference.

Hence, the method according to the first aspect may be equivalently and/or analogously described as a method of preparing an ion-selective electrode, ISE, for an ion-selective electrode cell, the ion-selective electrode cell comprising the ISE and a reference electrode, RE, the method comprising steps of:

exposing the ISE and a second electrode to a solution including the ion;

providing a first current of a first set of currents, having a direction, between the ISE and the second electrode; and

providing a first current of a second set of currents having a reverse direction, between the ISE and the second electrode.

### ISEs

The International Union of Pure and Applied Chemistry (IUPAC) Gold Book defines an ion-selective electrode (also known as a working electrode, WE) as an electrochemical sensor, based on thin films or selective membranes as recognition elements, and an electrochemical half-cell equivalent to other half-cells of the zeroth (inert metal in a redox electrolyte), 1st, 2nd and 3rd kinds. These devices are distinct from systems that involve redox reactions (electrodes of zeroth, 1st, 2nd and 3rd kinds), although they often contain a 2nd kind electrode as the ‘inner’ or ‘internal’ reference electrode. The potential difference response has, as its principal component, the Gibbs energy change associated with permselective mass transfer (by ion-exchange, solvent extraction or some other mechanism) across a phase boundary. The ion-selective electrode must be used in conjunction with a reference electrode (i.e. ‘outer’ or ‘external’ reference electrode) to form a complete electrochemical cell. The measured potential differences (ion-selective electrode vs. outer reference electrode potentials) are linearly dependent on the logarithm of the activity of a given ion in solution. Comment: the term ‘ion-specific electrode’ is not recommended. The term ‘specific’ implies that the electrode does not respond to additional ions. Since no electrode is truly specific for one ion, the term ‘ion-selective’ is recommended as more appropriate. ‘Selective ion-sensitive electrode’ is a little-used term to describe an ion-selective electrode. ‘Principal’ or ‘primary’ ions are those which an electrode is designed to measure. It is never certain that the ‘principal’ ion is most sensitively measured, e.g. nitrate ion-selective electrodes.

The IUPAC Gold Book defines an ion-selective electrode cell as an ion-selective electrode in conjunction with a reference electrode. Generally, the cell contains two reference electrodes, internal and external, and the thin film or membrane recognition-transduction element. However, besides this conventional type of cell (with solution contact on both sides of the membrane) there are cell arrangements with wire contact to one side of the membrane (all solid state and coated wire types).

It should be understood that the ISE is thus an ion-selective electrode and the RE is a reference electrode, according to these IUPAC Gold Book definitions.

There are four main types of ion-selective membrane used in ion-selective electrodes: glass, solid state, liquid-based, and compound electrode. In one example, the ISE comprises and/or is a glass membrane ISE, a solid-state ISE, a liquid-based ISE or a compound electrode ISE.

Glass membranes are typically made from an ion-exchange type of glass (silicate or chalcogenide), though typically suitable for some single-charged cations such as H⁺, Na⁺, and Ag⁺. Chalcogenide glass also has selectivity for double-charged metal ions, such as Pb²⁺, and Cd²⁺.

Crystalline membranes are made from mono- or polycrystallites of a single substance and confer good selectivity on ISEs, because only ions that can introduce themselves into the crystal structure can interfere with the electrode response.

Ion-exchange resin membranes are based on organic polymer membranes which include a specific ion-exchange substance (resin). ISEs using ion-exchange resin membranes are in widespread use, including for analysis of anions. Usage of specific resins allows preparation of ISEs for tens of different ions, both single-atom or multi-atom. However, such ISEs tend to have low chemical and physical durability as well as ‘survival time’. Alkali metal ISE have been developed specifically for each alkali metal ion: Li⁺, Na⁺, K⁺, Rb⁺ and Cs⁺. The respective alkali metal ions are encapsulated in molecular cavities sized to match the ions. For example, a polymer-based membrane comprising an ionophore such as valinomycin or potassium ionophore III may be used for the determination of K⁺. Alkaline earth metal ISE have been developed specifically for each alkali metal ion: Be²⁺, Mg²⁺, Ca²⁺, Sr²⁺ and Ba²⁺. The respective alkaline metal ions are encapsulated in molecular cavities sized to match the ions. For example, a polymer-based membrane comprising an ionophore such as magnesium ionophore I may be used for the determination of Mg²⁺ or calcium ionophore IV for the determination of Ca²⁺.

Enzyme electrodes are not true ion-selective electrodes but usually are considered within the ion-specific electrode topic. Such electrodes feature a double reaction mechanism in which an enzyme reacts with a specific substance, and the product of this reaction (usually H⁺ or OH⁻) is detected by a true ISE, such as a pH-selective electrode. An example is a glucose selective electrode.

In one example, the ISE comprises a membrane selected from a group comprising: a glass membrane, a crystalline membrane and an ion-exchange membrane, for example a polymer-based membrane.

### Preparing the Ion-Selective Electrode

The method is of preparing the ion-selective electrode cell, wherein the ion-selective electrode cell comprises the ISE and the RE. It should be understood that the method is of preparing the ISE for potentiometric, galvanometric and/or impedance measurements. Particularly, the method of preparing the ISE may be considered or termed a method of conditioning, pre-conditioning or treating the ISE, notwithstanding that such conditioning contrasts with conventional conditioning, as described herein.

### Ion-Selective Electrode Cell

In one example, the ion-selective electrode cell comprises the ISE and the RE provided on a substrate, as described below, and respective tracks for electrically coupling the ISE and the RE to a circuit, for example to a potentiometric circuit such as including a potentiometer and/or a galvanometric circuit (also known was an amperometric circuit), for example provided by the ISE. Hence, it should be understood that the ion-selective electrode cell does not include a potentiometric circuit such as including a potentiometer and/or a galvanometric circuit. In this way, a cost and/or a complexity of the ion-selective electrode cell may be reduced, such that the ion-selective electrode cell may be single-use (i.e. disposable) ion-selective electrode cell, electrically coupleable to a potentiometric circuit and/or a galvanometric circuit, for example provided by a device according to the fifth aspect. Two electrode ion-selective electrode cells (i.e. including the ISE and the RE) may be used for potentiometric measurements. In one example, the ion-selective electrode cell comprises a counter electrode (CE) (also known as an auxiliary electrode, AE). Three electrode ion-selective electrode cells (i.e. including the ISE, the RE and the CE) may be used for potentiometric and/or galvanometric measurements. In one example, the ion-selective electrode cell is a two electrode ion-selective electrode cell, comprising the ISE and the RE. In one example, the ion-selective electrode cell is a three electrode ion-selective electrode cell, comprising the ISE, the RE and a counter electrode, CE. In one example, the second electrode is the RE or the CE. In one preferred example, the ion-selective electrode cell is a three electrode ion-selective electrode cell, comprising the ISE, the RE and a counter electrode, CE, wherein the second electrode is the CE.

### Nernstian Response

Generally, ion selective electrodes, ISEs, are transducers (also known as sensors) that convert ionic activities of specific ions in solutions into electrical responses, for example electrical potentials. The electrical potentials are theoretically dependent on the logarithms of the ionic activities, according to the Nernst equation:

$$E = {E}^{0} + \frac{R T}{{z}_{I} F} ln {a}_{I}$$

where

E is the expected electrical potential;

E⁰ is the standard electrical potential;

R is the universal gas constant;

T is the absolute temperature;

z_{I} is the charge on the ion (also known as ion of interest or primary ion);

F is Faraday's constant; and

a_{I} is the activity of the ion in the solution.

Hence, an ISE exhibits a Nernstian response if a ×10 change in the activity a_{I} of the ion results in approximately a 60 mV or a 30 mV change in the electrical potential E, for monovalent and for divalent ions respectively. In contrast, an ISE exhibits a super-Nernstian response when the ×10 change in the activity a_{I} of the ion results in a significantly larger change in the electrical potential E, for example exceeding 60 mV, 120 mV, 240 mV or even 700 mV for a monovalent ion.

Generally, the activity a_{I} of the ion is a measure of the ‘effective concentration’ of the ion in a mixture, in the sense that the ions' chemical potential depends on the activity of a real solution in the same way that it would depend on concentration for an ideal solution. However, a concentration of the ion is typically used in practice, rather than the activity a_{I} of the ion.

A polymer-based ISE typically comprises: an ionophore, to render selectivity to a membrane by forming a stable complex with the ion of interest; an ion-exchanger, to provide electroneutrality and ensure permselectivity; and a polymer matrix to provide support and mechanical functionality to the membrane. The polymer-based ISE response is now dictated by the phase boundary potential E_{PB}:

$${E}_{P B} = {E}^{0} + \frac{R T}{{z}_{I} F} ln \frac{{a}_{I , aq}}{{a}_{I , org}}$$

where:

a_{I,aq} is the activity of the ion in an aqueous phase; and

a_{I,org} is the activity of the ion in an organic phase.

In order to exhibit a Nernstian response, the activity of the ions in the bulk of the organic phase a_{I,org} must remain constant and independent of the sample. Therefore, the E_{PB} in such a case may be reduced to the Nernst equation:

$${E}_{P B} = {E}^{0 ′} + \frac{R T}{{z}_{I} F} ln {a}_{I , aq}$$

Conventionally, the polymer-based ISE must be exposed to the ion of interest, to allow the ionophore to chelate the ion of interest. This well-known conventional process is known as conditioning, involving exposing the ISE to a high concentration of the ion of interest in solution, in a process that can take from 12 to 72 hours. During this time, the membrane becomes hydrated and ideally reaches equilibrium through ion exchange processes in which ions of interest from the solution replace, ideally fully, ions in the membrane having the same charge.

For a cation-selective membrane, the established equilibrium process of this conventional conditioning may be represented by:

I_{aq}^{z+}+nL_{org}+M_{org}⁺R_{org}⁻≈[ILₙ]_{org}^{z+}+M_{aq}⁺+R_{aq}⁻

where:

L is the ligand that forms the ion-ionophore complex with the ion of interest I^{z+}, with stoichiometry n; and

M_{org}⁺R_{org}⁻ is the ion-exchanger, composed of a lipophilic anion R⁻ and a cation M⁺.

The cation M⁺ will partition to the aqueous phase and exchange with the ion of interest I^{z+}. The lipophilic anion R⁻ will remain in the membrane to retain electroneutrality and allow permselectivity. This lengthy conditioning effectively prevents practical and efficient applications of these polymer-based ISEs.

### Screen-Printed Electrodes

In one example, the ISE and/or the RE is a screen-printed electrode (SPE), for example screen-printed on a substrate formed from a polymeric material such as polyester (PE), polypropylene (PP), a ceramic or paper. Other substrates are known. Generally, screen printing provides manufacture of SPEs in a reproducible, low-cost, and disposable format, while allowing ready incorporation of chemically functionalized materials. Screen-printing process has three main advantages over conventional methods of electrode manufacture: electrode area, electrode thickness, and electrode composition are readily controlled; statistical validation of experimental results is provided by replicate electrodes; and catalysts can be incorporated addition to screen-printing ink (paste). However, screen printing is generally restricted to planar substrates.

In one example, the ISE comprises and/or is formed, at least in part, from carbon, gold and/or platinum. Preferably, the ISE comprises and/or is formed, at least in part, from carbon, for example formed by screen-printing carbon ink onto a substrate.

In one example, the ISE comprises an ion-selective coating, for example overlaying carbon, gold and/or platinum. In one example, the ion-selective coating comprises a polymeric membrane providing a matrix, for example a neutral carrier-based solvent polymeric membrane such as based on plasticized poly(vinyl chloride) (PVC), polyurethane or a UV curable resin such as PU acrylate with acrylic monomer, comprising an ionophore, such as valinomycin, potassium ionophore III, magnesium ionophore I or calcium ionophore IV therein.

In one preferred example, the ISE comprises carbon and an ion-selective coating overlaying the carbon, wherein the ion-selective coating comprises a polymeric membrane providing a matrix, for example a neutral carrier-based solvent polymeric membrane such as based on plasticized poly(vinylchloride) (PVC), polyurethane or a UV curable resin such as PU acrylate with acrylic monomer, comprising an ionophore, such as valinomycin, potassium ionophore III, magnesium ionophore I or calcium ionophore IV therein.

In one example, the RE comprises and/or is a Ag or a Ag/AgCl reference electrode. In one preferred example, the RE is a Ag/AgCl reference electrode, for example, provided by screen-printing Ag/AgCl ink onto a substrate. In one example, the RE comprises and/or is a solid-state RE, for example based on doped conjugated and redox polymers, polymer composites and/or polymer electrolytes, such as derivatives of polypyrrole, polyamine and/or polythiophene. In one example, the RE comprises and/or is a poly(3,4-ethylenedioxythiophene) (PEDOT) doped with poly(styrenesulfonate) (PSS) reference electrode. Other REs are known, including metal and/or carbon REs, such as saturated calomel electrode, copper-copper (II) sulphate electrode, palladium-hydrogen electrode and mercury-mercurous sulfate electrode.

In one example, the ion-selective electrode cell comprises a counter electrode (CE). In one example, the CE comprises and/or is formed, at least in part, from carbon, gold and/or platinum, as described with respect to the ISE. In one preferred example, the CE comprises and/or is formed, at least in part, from carbon, for example, formed by screen-printing carbon ink onto a substrate, as described with respect to the ISE. In one example, the CE is uncoated (i.e. in contrast to the ISE).

### Exposing

The method comprises exposing the ISE and the second electrode to the solution including the ion. It should be understood that exposing the ISE and the second electrode to the solution including the ion comprises electrically coupling the ISE and the second electrode via the solution including the ion. For example, the solution including the ion may wet the ISE, the second electrode and therebetween. For example, the solution including the ion, such as a droplet or a layer thereof, may extend from the ISE to the second electrode. For example, the ISE and the second electrode may be immersed in the solution including the ion.

In one example, exposing the ISE and the second electrode to the solution including the ion comprises electrically coupling, for example electronically, ionically, cationically and/or anionically, the ISE and the second electrode via the solution including the ion. In one example, exposing the ISE and a second electrode to the solution including the ion comprises and/or is by contacting, for example wetting, the ISE and the second electrode with the solution including the ion. In one example, exposing the ISE and the second electrode to the solution including the ion comprises and/or is by depositing the solution including the ion, for example a droplet or a layer thereof, on the ion-selective electrode cell, from the ISE to the second electrode. In one example, exposing the ISE and the second electrode to the solution including the ion comprises and/or is by immersing the ISE and the second electrode in the solution including the ion.

In one example, the ion-selective electrode cell comprises a CE and the method comprises exposing the CE to the solution including the ion, as described with respect to the ISE and/or the RE. In one preferred example, the second electrode is the CE.

### Ion

In one example, the ion is a monovalent ion, for example a monovalent cation or a monovalent anion. In one example, the ion is an alkali metal cation, for example Li⁺, Na⁺, K⁺, Rb⁺ or Cs⁺. In one example, the ion is an alkali earth metal cation, for example Be²⁺, Mg²⁺, Ca²⁺, Sr²⁺, Ba²⁺ or Ra²⁺. In one example, the ion is a transition metal cation, for example of Sc, Ti, V, Cr, Mn, Fe, Co, Ni, Cu or Zn, or a second-row transition metal cation, for example of Y, Zr, Nb, Mo, Tc, Ru, Rh, Pd, Ag or Cd, or a heavy metal cation, for example of Pb. In one example, the ion is a monovalent anion, for example F⁻, Cl⁻, Br⁻, I⁻, CN⁻ NO₃⁻ or HCO₃⁻, a divalent anion, for example HPO₄²⁻, S²⁻, or SO₄²⁻ or a trivalent anion, for example PO₄³⁻. NO₃⁻, PO₄³⁻ and/or K⁺ are commonly measured for soil tests, as these macronutrients are important to plant growth. Micronutrients such as Mg²⁺, Cu²⁺ and/or Zn²⁺ may also be measured for soil tests.

### Solution

In one example, the solution is an aqueous solution. In one example, the solution is part of a suspension, a slurry or a mixture. In one example, the solution is a sample, for example an environmental chemistry, a food research, a biomedical, a biochemical or a biophysical sample. In one example, the solution is provided by a biological fluid, for example blood, whole blood, plasma, serum, urine, mucus, saliva and/or sweat.

### First PD of the First Set of PDs

The method comprises applying the first PD of the first set of PDs, having the polarity, across the ISE and the second electrode. It should be understood that the ISE and the RE are exposed to the solution including the ion while applying the first PD of the first set of PDs, having the polarity, across the ISE and the second electrode, wherein the ISE and the RE are electrically coupled via the solution including the ion.

In one example, the first PD of the first set of PDs comprises a part of, for example a positive part or a negative part, of a waveform, for example an uni-directional, a bi-directional, a periodic, a non-periodic, a symmetrical, a non-symmetrical, a simple and/or a complex waveform such as a sine waveform, a rectangular waveform, a square waveform, a pulse waveform, a ramp waveform, a sawtooth waveform and/or a triangular waveform. Other waveforms are known. In one example, the first set of PDs includes M PDs including the first PD, wherein M is a natural number of at least 1, for example 1, 2, 3, 4, 5, 6, 7, 8, 9, 10, 15, 20, 25, 30, 35, 40, 45, 50, 60, 70, 80, 90, 100, 200, 300, 400, 500, 600, 700, 800, 900, 1000 or more. The M PDs of the first set of PDs may be as described with respect to the first PD of the first set of PDs. Alternatively, the M PDs of the first set of PDs may have mutually different magnitudes and/or durations.

### First PD of the Second Set of PDs

The method comprises applying the first PD of the second set of PDs, having the reverse polarity, across the ISE and the second electrode.

It should be understood that the ISE and the second electrode are exposed to the solution including the ion while applying the first PD of the second set of PDs, having the polarity, across the ISE and the second electrode, wherein the ISE and the second electrode are electrically coupled via the solution including the ion.

It should be understood that the reverse polarity of the first PD of the second set of PDs is thus reverse to the polarity of the first PD of the first set of PDs. For example, if the polarity of the first PD of the first set of PDs is positive, then the reverse polarity of the first PD of the second set of PDs is thus negative. Conversely, if the polarity of the first PD of the first set of PDs is negative, then the reverse polarity of the first PD of the second set of PDs is thus positive. In other words, the method comprises applying PDs, having reversed (i.e. opposed) polarities, across the ISE and the second electrode.

In one example, the first PD of the second set of PDs comprises a part of, for example a positive part or a negative part, of a waveform, for example an uni-directional, a bi-directional, a periodic, a non-periodic, a symmetrical, a non-symmetrical, a simple and/or a complex waveform such as a sine waveform, a rectangular waveform, a square waveform, a pulse waveform, a ramp waveform, a sawtooth waveform and/or a triangular waveform. Other waveforms are known. In one example, the second set of PDs includes N PDs including the first PD, wherein N is a natural number of at least 1, for example 1, 2, 3, 4, 5, 6, 7, 8, 9, 10, 15, 20, 25, 30, 35, 40, 45, 50, 60, 70, 80, 90, 100, 200, 300, 400, 500, 600, 700, 800, 900, 1000 or more. The N PDs of the second set of PDs may be as described with respect to the first PD of the second set of PDs. Alternatively, the M PDs of the second set of PDs may have mutually different magnitudes and/or durations.

It should be understood that the step of applying the first PD of the second set of PDs, having the reverse polarity, across the ISE and the second electrode may be performed before and/or after the step of applying the first PD of the second set of PDs, having the reverse polarity, across the ISE and the second electrode. For example, a positive voltage may be applied across the ISE and the second electrode and subsequently, a negative voltage applied thereacross, or vice versa.

In one example, the method comprises applying the first PD of the first set of PDs and the first PD of the second set of PDs to provide a bi-directional, symmetrical or non-symmetrical rectangular waveform or square waveform, preferably a bi-directional, non-symmetrical rectangular waveform.

In one example, the first set of PDs includes M PDs including the first PD thereof and/or wherein the second set of PDs includes N PDs including the first PD thereof, wherein M and N are natural numbers of at least 1 and wherein M+N is greater than or equal to 3, wherein the method comprises alternately applying at least one of the PDs of the first set of PDs and applying at least one PD of the second set of PDs. In other words, respective PDs of the first set of PDs and of the second set of PDs may be applied alternately.

In one example, the method comprises applying the M PDs of the first set of PDs and the N PDs of the second set of PDs alternately to provide a bi-directional, symmetrical or non-symmetrical rectangular wave or square wave, preferably a bi-directional, non-symmetrical rectangular waveform.

In one example, the first PD of the first set of PDs is constant and/or the first PD of the second set of PDs is constant.

In one example, applying the first PD of the first set of PDs and/or the first PD of the second set of PDs comprises, at least in part, initiating ion flux into and/or out of the ISE. Without wishing to be bound by any theory, a magnitude of the first PD of the first set of PDs and/or of the first PD of the second set of PDs should be large enough to initiate ion flux into the membrane so that the membrane can become electrically preconditioned and to larger extent become accessible to ions. It should be understood that initiating ion flux into and/or out of the ISE depends on the polarity and whether the ion is an anion or a cation.

In one example, applying the first PD of the first set of PDs and/or the first PD of the second set of PDs comprises applying the first PD of the first set of PDs having a magnitude of at most a damage threshold of the ISE. Without wishing to be bound by any theory, while the magnitude of the first set of PDs and/or of the first PD of the second set of PDs should be large enough to initiate ion flux, as described above, the magnitude of the first set of PDs and/or of the first PD of the second set of PDs should not be so large as to damage the membrane, for example a surface thereof.

In one example, applying the first PD of the second set of PDs and/or the first PD of the first set of PDs comprises removing, at least in part, excess surface charge of the ISE. Without wishing to be bound by any theory, this step may remove excessive surface charge, for example arising from a discharge capacitor created by a double layer of the membrane and solution, and/or minimize potential drift during electrical response measurement for example potential, such as open circuit potential (OCP), (i.e. potentiometric) measurement, current measurement and/or impedance measurement.

In one example, applying the first PD of the second set of PDs and/or the first PD of the first set of PDs comprises applying the first PD of the second set of PDs and/or the first PD of the first set of PDs having a magnitude in a range from ER/8 to 8×ER, preferably in a range from ER/4 to 4×ER, more preferably in a range from ER/2 to 2×ER, more preferably in a range from 3×ER/4 to 5×ER/4, most preferably in a range from 7×ER/8 to 9×ER/8, where ER is the electrical response, ER, of the ion-selective electrode cell due, at least in part, to the ion. In one example, applying the first PD of the second set of PDs and/or the first PD of the first set of PDs comprises applying the first PD of the second set of PDs and/or the first PD of the first set of PDs having a magnitude in a range from OCP/8 to 8×OCP, preferably in a range from OCP/4 to 4×OCP, more preferably in a range from OCP/2 to 2×OCP, more preferably in a range from 3×OCP/4 to 5×OCP/4, most preferably in a range from 7×OCP/8 to 9×OCP/8, where OCP is the open circuit potential, OCR between the ISE and RE due, at least in part, to the ion. For example, if the expected OCP is 200 mV, a magnitude of the first PD of the first set of PDs and/or of the first PD of the second set of PDs may be in a range from 25 mV to 1600 mV, preferably in a range from 50 mV to 800 mV, more preferably in a range from 100 mV to 200 mV, even more preferably in a range from 150 mV to 250 mV, most preferably in a range from 175 mV to 225 mV. Without wishing to be bound by any theory, the magnitude of the first PD of the first set of PDs and/or of the first PD of the second set of PDs is preferably as close to the electrical response, for example the OCP, as possible in order to avoid disturbing ion equilibrium near the membrane that could initiate unwanted potential drift during the electrical response, for example the OCP, measurement. In one example, applying the first PD of the second set of PDs and/or the first PD of the first set of PDs comprises applying the first PD of the second set of PDs and/or the first PD of the first set of PDs having a magnitude in a range from 0.1 mV to 5000 mV, preferably in a range from 1 mV to 1000 mV, more preferably in a range from 10 mV to 750 mV, more preferably in a range from 50 mV to 500 mV, most preferably in a range from 100 mV to 250 mV. In one example, a maximum magnitude of the first PD of the second set of PDs and/or the first PD of the first set of PDs is determined, at least in part, according to the solution, for example so as to reduce and/or avoid oxidation and/or reduction of a solvent included in the solution. For example, for an aqueous solution, the maximum magnitude may correspond with the standard potential of a water electrolysis cell of −1.23V vs Ag/AgCl at 25° C. at pH 0.

In one example, applying the first PD of the first set of PDs comprises applying the first PD of the first set of PDs for a duration in a range from 1 μs to 100 s, 10 μs to 100 s, 100 μs to 100 s, 1 ms to 100 s, preferably in a range from 1 μs to 10 s, 10 μs to 10 s, 100 μs to 10 s, 1 ms to 10 s, 100 ms to 10 s, more preferably in a range from 1 μs to 5 s, 10 μs to 5 s, 100 μs to 5 s, 1 ms to 5 s, 10 ms to 5 s, 100 ms to 5 s, 1 s to 5 s, for example 3 s; and/or applying the first PD of the second set of PDs comprises applying the first PD of the second set of PDs for a duration in a range from 1 μs to 100 s, 10 μs to 100 s, 100 μs to 100 s, 1 ms to 100 s, preferably in a range from 1 μs to 10 s, 10 μs to 10 s, 100 μs to 10 s, 1 ms to 10 s, 100 ms to 10 s, more preferably in a range from 1 μs to 5 s, 10 μs to 5 s, 100 μs to 5 s, 1 ms to 5 s, 10 ms to 5 s, 100 ms to 5 s, 1 s to 5 s, for example 3 s.

In one example, applying the first PD of the second set of PDs comprises applying the first PD of the second set of PDs within a period after applying the first PD of the first set of PDs, wherein the period is in a range from 0 ms to 100 s, 1 μs to 100 s, 10 μs to 100 s, 100 μs to 100 s, 1 ms to 100 s, preferably in a range from 1 μs to 10 s, 10 μs to 10 s, 100 μs to 10 s, 1 ms to 10 s, 100 ms to 10 s, more preferably in a range from 1 μs to 5 s, 10 μs to 5 s, 100 μs to 5 s, 1 ms to 5 s, 10 ms to 5 s, 100 ms to 5 s, 1 s to 5 s, for example 20 ms. In other words, the period comprises and/or is a delay. That is, applying the first PD of the second set of PDs may be shortly after, preferably immediately after applying the first PD of the first set of PDs.

In one example, the method comprises measuring a current between the ISE and the second electrode while applying the first PD of the first set of PDs and/or while applying the first PD of the second set of PDs. In one example, the ion-selective electrode cell comprises counter electrode, CE, and the method comprises measuring a current between the ISE and the CE while applying the first PD of the first set of PDs and/or while applying the first PD of the second set of PDs. The inventors have identified that the measured current may provide useful information about the ionic activity of the solution and/or about the ISE, the RE and/or the CE. This information may be used to calibrate the ion-selective electrode cell (i.e. self-calibrate, auto-calibrate) and/or to correct for the solution and/or for the ISE, the RE and/or the CE, such as due to manufacturing tolerances.

### Control

In one example, applying the first PD of the first set of PDs, having the polarity, across the ISE and the second electrode comprises controlling the first PD of the first set of PDs, for example according to a threshold value, a desired PD profile as a function of time, and/or a feedback such as from a potential difference, a current and/or an impedance measured while applying the first PD of the first set of PDs. In other words, applying the first PD of the first set of PDs may be voltage-controlled. In this way, the ion-selective electrode cell may be individually prepared, for example according to a design or manufacture thereof, to account for degradation during storage (i.e. ageing) and/or specifically for the ion and/or the solution. Conversely, in one example, the method comprises providing a first current of a first set of currents, having a direction, between the ISE and the second electrode, wherein providing the first current of the first set of currents comprises controlling the first current of the first set of currents, for example according to a threshold value, a desired current profile as a function of time, and/or a feedback such as from a potential difference, a current and/or an impedance measured while applying the first PD of the first set of PDs. In other words, providing the first current of the first set of currents may be current-controlled. Impedance control may be similarly provided. Applying the first potential difference, PD, of the second set of PDs, having the reverse polarity, across the ISE and the second electrode and/or providing a first current of a second set of currents, having a reverse direction, between the ISE and the second electrode may be similarly controlled, as described above with respect to the first PD of the first set of PDs and the first current of the first set of currents, respectively.

### Preferred Example

In one preferred example, the method is of preparing the ion-selective electrode, ISE, for the ion-selective electrode cell, the ion-selective electrode cell comprising the ISE and the reference electrode, RE, the method comprising the steps of:

exposing the ISE and the second electrode to the solution including the ion;

applying the first potential difference, PD, of the first set of PDs, having the polarity, across the ISE and the second electrode; and

applying the first potential difference, PD, of the second set of PDs, having the reverse polarity, across the ISE and the second electrode;

wherein the ISE is a solid-state ISE having an ion-selective coating such as an ion-exchange resin membrane, preferably polymer-based membrane such as based on plasticized poly(vinylchloride) (PVC), polyurethane or a UV curable resin such as PU acrylate with acrylic monomer comprising an ionophore such as valinomycin, potassium ionophore III, magnesium ionophore I or calcium ionophore IV;

wherein the ion-selective electrode cell is a three electrode ion-selective electrode cell, comprising the ISE, the RE and a counter electrode, CE, wherein the second electrode is the CE;

wherein the ISE, the RE and/or the CE comprise and/or are formed, at least in part, from carbon, gold and/or platinum, for example wherein the ISE, the RE and/or the CE are screen-printed electrodes, SPEs, comprising and/or formed, at least in part, from carbon, preferably formed by screen-printing carbon ink onto a substrate;

wherein the RE comprises and/or is a Ag or a Ag/AgCl reference electrode; and wherein exposing the ISE and the second electrode to the solution including the ion comprises wetting the ISE, the second electrode and therebetween.

### Method of Determining a Presence of an Ion in a Solution

The second aspect provides a method of determining a presence of an ion in a solution using an ion-selective electrode cell comprising an ion-selective electrode, ISE, and a reference electrode, RE, the method comprising steps of:

preparing the ISE according to the first aspect using the solution; and determining the presence of the ion in the solution, for example potentiometrically,

galvanometrically and/or by impedance, using the ion-selective electrode cell including the prepared ISE, preferably within 300 s of completing the step of preparing of the ISE.

In this way, by preparing the ISE according to the first aspect using the solution and subsequently determining the presence of the ion in the solution, for example potentiometrically, galvanometrically and/or by impedance, the preparing is thus performed in situ, as described above, while a response time, an accuracy, a precision and/or a reproducibility of the measurement are improved, as described above.

The ion, the solution, the ion-selective electrode cell, the ISE, the RE sensor and/or determining the presence of the ion in the solution, for example potentiometrically, galvanometrically and/or by impedance, using the ISE may be as described with respect to the first aspect.

In one example, determining the presence of the ion in the solution, for example potentiometrically, galvanometrically and/or by impedance, using the ion-selective electrode cell is within 300 s, preferably within 120 s, more preferably within 60 s, even more preferably within 30 s, most preferably within 10 s, for example within 5 s, 4 s, 3 s, 2 s or 1 s of completing the preparing of the ion-selective electrode cell. That is, determining the presence of the ion in the solution may be shortly after, preferably immediately after preparing the ion-selective electrode cell.

### Ion-Selective Electrode

The third aspect provides an ion-selective electrode, ISE, prepared according to the first aspect The ion-selective electrode cell, the ISE, the RE and/or the second electrode may be as described with respect to the first aspect and/or the second aspect.

In this way, by preparing the ISE according to the first aspect using the solution, a subsequent determination of a presence of an ion in a solution, for example potentiometrically, galvanometrically and/or by impedance, using the ion-selective electrode cell, a response time, an accuracy, a precision and/or a reproducibility of the measurement are improved, as described above.

### Ion Selective Electrode Cell

The fourth aspect provides an ion selective electrode cell, comprising an ion-selective electrode, ISE, according to the third aspect and a reference electrode, RE.

The ion-selective electrode cell, the ISE, the RE and/or the second electrode may be as described with respect to the first aspect, the second aspect and/or the third aspect.

### Device

The fifth aspect provides a device for preparing an ion-selective electrode, ISE, for an ion-selective electrode cell, the ion-selective electrode cell comprising the ISE and a reference electrode, RE, wherein the device is configured to:

apply a first potential difference, PD, of a first set of PDs, having a polarity, across the ISE and a second electrode; and

apply a first potential difference, PD, of a second set of PDs, having a reverse polarity, across the ISE and the second electrode.

The ion-selective electrode cell, the ISE, the RE, the second electrode, the first PD of the first set of PDs having the polarity and/or the first PD of the second set of PDs having the reverse polarity may be as described with respect to the first aspect, the second aspect, the third aspect and/or the fourth aspect.

In one example, the device comprises a voltage supply, configured to apply the first potential difference, PD, of the first set of PDs, having the polarity, across the ISE and the second electrode and/or to apply the first potential difference, PD, of the second set of PDs, having the reverse polarity, across the ISE and the second electrode.

In one example, the device comprises a controller, for example comprising a processor and a memory, configured to control the first potential difference, PD, of the first set of PDs, having the polarity, across the ISE and the second electrode and/or the first potential difference, PD, of the second set of PDs, having the reverse polarity, across the ISE and the second electrode.

In one example, the device comprises a potentiometer for measuring a voltage across the ISE and the second electrode, a galvanometer for measuring a current between the ISE and the second electrode and/or means for measuring an impedance of the ion-selective electrode cell.

### Ion-Selective Electrode Cell Assembly

The sixth aspect provides an ion-selective electrode cell assembly, or a kit for an ion-selective electrode cell assembly, comprising:

an ion-selective electrode cell comprising an ion-selective electrode, ISE, and a reference electrode, RE; and

a device according to the fifth aspect.

### Use

The seventh aspect provides use of in situ reversed polarities to condition an ion selective electrode, ISE, for determining a presence of an ion in a solution. In this way, a response time and/or a baseline stability of the ISE may be improved. In contrast to conventional methods of conditioning ISEs, involves exposing the ISEs to high concentrations of the specific ions in a process that can take from 12 to 72 hours, applying reverse polarities to the ISE in the same solution as the determination of the ion (i.e. in situ), effectively conditions the ISE, as described herein.

### Definitions

Throughout this specification, the term “comprising” or “comprises” means including the component(s) specified but not to the exclusion of the presence of other components. The term “consisting essentially of” or “consists essentially of” means including the components specified but excluding other components except for materials present as impurities, unavoidable materials present as a result of processes used to provide the components, and components added for a purpose other than achieving the technical effect of the invention, such as colourants, and the like.

The term “consisting of” or “consists of” means including the components specified but excluding other components.

Whenever appropriate, depending upon the context, the use of the term “comprises” or “comprising” may also be taken to include the meaning “consists essentially of” or “consisting essentially of”, and also may also be taken to include the meaning “consists of” or “consisting of”.

The optional features set out herein may be used either individually or in combination with each other where appropriate and particularly in the combinations as set out in the accompanying claims. The optional features for each aspect or exemplary embodiment of the invention, as set out herein are also applicable to all other aspects or exemplary embodiments of the invention, where appropriate. In other words, the skilled person reading this specification should consider the optional features for each aspect or exemplary embodiment of the invention as interchangeable and combinable between different aspects and exemplary embodiments.

### BRIEF DESCRIPTION OF THE DRAWINGS

For a better understanding of the invention, and to show how exemplary embodiments of the same may be brought into effect, reference will be made, by way of example only, to the accompanying diagrammatic Figures, in which:

FIG. 1 schematically depicts a method of preparing an ion-selective electrode, ISE, for an ion-selective electrode cell, according to an exemplary embodiment;

FIG. 2 schematically depicts the method of FIG. 1, in more detail;

FIG. 3 shows graphs of measured OCPs as a function of time for ion-selective electrode cells prepared according to the method of FIG. 1 and for comparative ion-selective electrode cells, using ink A;

FIGS. 4A and 4B shows graphs of measured OCPs (as measured and normalised, respectively) as a function of log[K⁺] for ion-selective electrode cells prepared according to the method of FIG. 1 and for comparative ion-selective electrode cells, using ink A;

FIGS. 5A and 5B shows graphs of measured OCPs (as measured and normalised, respectively) as a function of log[K⁺] for ion-selective electrode cells prepared according to the method of FIG. 1 and for comparative ion-selective electrode cells, using ink B;

FIGS. 6A and 6B shows graphs of measured OCPs (as measured and normalised, respectively) as a function of log[K⁺] for ion-selective electrode cells prepared according to the method of FIG. 1 and for comparative ion-selective electrode cells, using ink C;

FIG. 7 shows graphs of current measured between the ISE and the CE for ion-selective electrode cells prepared according to the method of FIG. 1;

FIG. 8 schematically depicts an ion-selective electrode cell according to an exemplary embodiment;

FIG. 9 schematically depicts an ion-selective electrode cell according to an exemplary embodiment;

FIG. 10 schematically depicts a circuit for an ion-selective electrode cell according to an exemplary embodiment;

FIG. 11 schematically depicts a circuit for an ion-selective electrode cell according to an exemplary embodiment;

FIG. 12 schematically depicts an exploded, perspective view of an ion-selective electrode cell according to an exemplary embodiment;

FIG. 13 schematically depicts examples of applying potential differences for the method of FIG. 1, in more detail;

FIG. 14A schematically depicts a circuit for an ion-selective electrode cell according to an exemplary embodiment; and FIG. 14B schematically depicts potential gradients in the ion-selective electrode cell of FIG. 14A;

FIG. 15A schematically depicts a circuit for an ion-selective electrode cell according to an exemplary embodiment; and FIG. 15B schematically depicts potential gradients in the ion-selective electrode cell of FIG. 15A;

FIG. 16 schematically depicts a circuit for an ion-selective electrode cell according to an exemplary embodiment;

FIG. 17A shows photographs of 6 ion-selective electrode cells prepared according to the method of FIG. 1; and FIG. 17B shows graphs of current measured between the ISE and the CE as a function of time upon changing an applied potential difference from −200 mV to +480 mV at t=3 s for the 6 ion-selective electrodes of FIG. 17A;

FIG. 18A shows a graph of measured OCP (as measured) as a function of time for ion-selective electrode cells prepared according to the method of FIG. 1 and for comparative ion-selective electrode cells; and FIG. 18B shows a graph of as measured OCP as a function of log[K⁺] for the ion-selective electrode cells and for the comparative ion-selective electrode cells of FIG. 18A;

FIG. 19 shows a graph of as measured OCP as a function of log[Mg²⁺ ] for ion-selective electrode cells prepared according to the method of FIG. 1 and for comparative ion-selective electrode cells; and

FIG. 20 shows a graph of as measured OCP as a function of time for ion-selective electrode cells prepared according to the method of FIG. 1 and for comparative ion-selective electrode cells.

### DETAILED DESCRIPTION OF THE DRAWINGS

### Method

FIG. 1 schematically depicts a method of preparing an ion-selective electrode, ISE, for an ion-selective electrode cell, according to an exemplary embodiment. The ion-selective electrode cell comprises the ISE and a reference electrode, RE.

At S101, the ISE and a second electrode are exposed to a solution including the ion.

At S102, a first potential difference, PD, of a first set of PDs, having a polarity, is applied across the ISE and the second electrode.

At S103, a first potential difference, PD, of a second set of PDs, having a reverse polarity, is applied across the ISE and the second electrode.

### Experimental

FIG. 2 schematically depicts the method of FIG. 1, in more detail.

Particularly, ion-selective electrode cells for sensing K⁺ were provided as described below.

### Electrodes

The ISE and a CE were provided, at least in part, by screen printing using commercially available carbon inks, obtained from DuPont® (Ink A: BQ242) and Gwent® (Ink B: C2110602D4) and Loctite (Ink C: EDAG PF 407A E&C), onto a polymeric substrate, particularly PE. The RE was provided by screen printing using commercially available Ag/AgCl ink, obtained from Gwent Group (C2130809D5), onto the polymeric substrate. The ISE, the CE and the RE were coated with a commercially available dielectric ink. The ISE, the CE and the RE each had diameters of 1 mm and hence exposed surface areas of 0.785 mm².

### Electrode Functionalisation

Polyvinyl chloride (PVC) 31.3%, bis(2-ethylhexyl) sebacate (DOS) 62.3%, potassium tetrakis(4-chlorophenyl)borate (KTpCIPB) 1.4% and valinomycin 5% were mixed in cyclohexanone, to provide a polymer mix. These chemicals were obtained from Sigma-Aldrich®. Particularly, 66 mg PVC, 143 μL DOS, 3 mg tetrakis(4-chlorophenyl)borate and 10 mg valinomycin were mixed in 1 mL cyclohexanone. 0.3 μl of the polymer mix was deposited on the screen printed carbon for the ISE, to provide a polymer layer having a thickness of about 10 μm to 20 μm. The ion-selective electrode cells were dried on a hotplate at 50° C. for 2 hours, transferred to an airtight container with desiccant and stored in the dark until use. Alternatively, the ion-selective electrode cells may be air-dried.

### Measurement Procedure

Standard potentiometric measurement of a potential of the ISE compared to the RE.

Comparative example ion-selective electrode cells, without preparing according to the method of the first aspect, were used for determining a presence of the ion in solution. A dry sensor (i.e. not conventionally conditioned), having the deposited PVC ion selective membrane, was immersed in PBS containing 2 mM potassium. After a 9 s delay, the OCP was measured for 50 s. The final potential difference between the ISE and the RE was measured every 1 s.

Example ion-selective electrode cells, prepared according to the method of the first aspect, were used for determining a presence of the ion in solution. Particularly, a negative potential difference and then a positive potential difference were applied across the ISE and the second electrode. In more detail, a dry sensor (i.e. not conventionally conditioned), having the deposited PVC ion selective membrane, was immersed in PBS containing 2 mM potassium. After a 2 s delay, the potential difference between the ISE and the RE was stepped between −200 mV (hold for 3 s) and +190 mV (hold for 3 s). After an additional 1 s delay (i.e. 9 s total, as for comparative example ion-selective electrode cells) the OCP was measured for another 50 s. Final potential difference between ion selective SPE and printed Ag/AgCl was measured and sampled every 1 s. The final potential difference between the ISE and the RE was measured every 1 s.

FIG. 3 shows graphs of measured OCPs as a function of time for ion-selective electrode cells prepared according to the method of FIG. 1 and for comparative ion-selective electrode cells, using ink A. The concentration of K⁺ [K⁺] is 2 mM.

The measured OCP for the comparative example ion-selective electrode cells stabilises asymptotically over at least 40 or 45 s. In contrast, the measured OCP for the example ion-selective electrode cells, prepared as described above, stabilise within 5 s or less. In addition, since the response time of the ion-selective electrode cell including the prepared ISE is improved, more measurements may be made while the signal is stable, thus improving a relative standard deviation (RSD) of the measurements, for example.

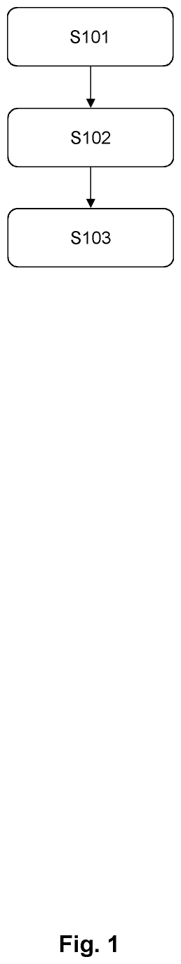

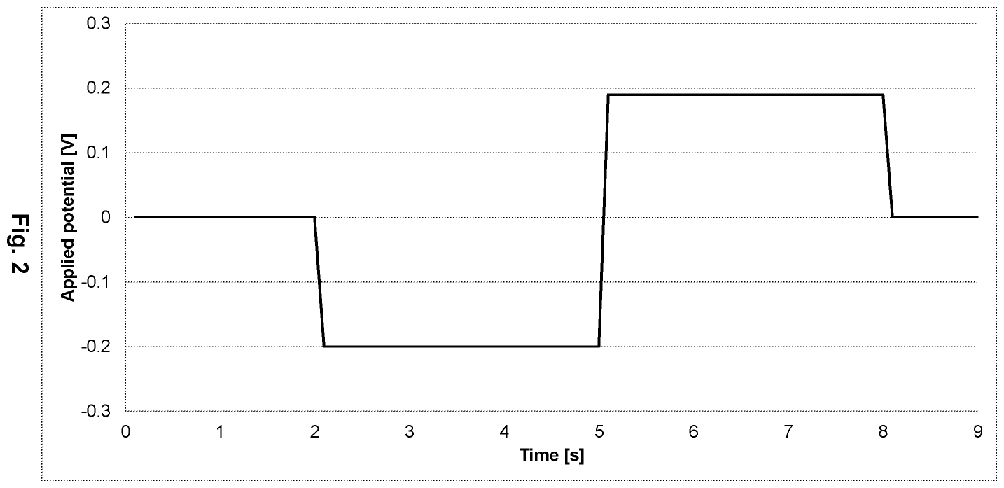

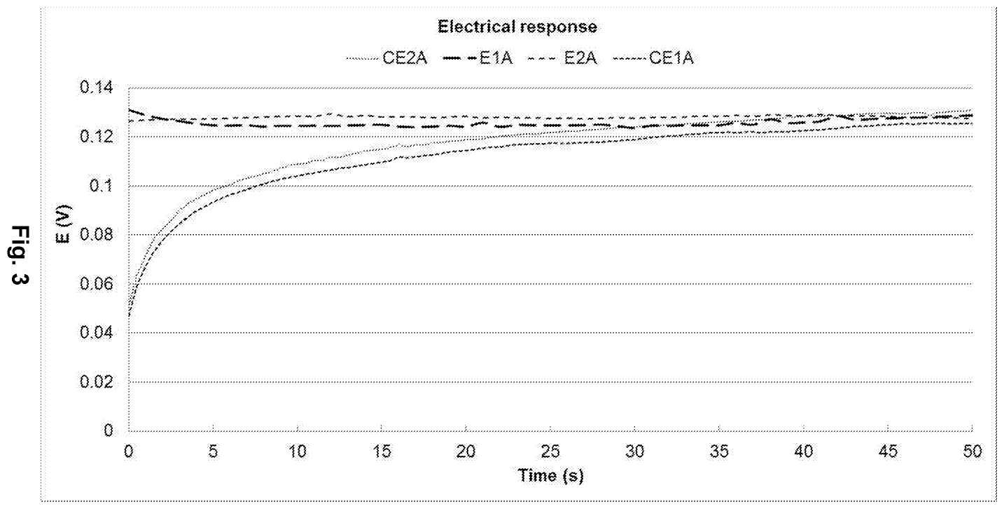

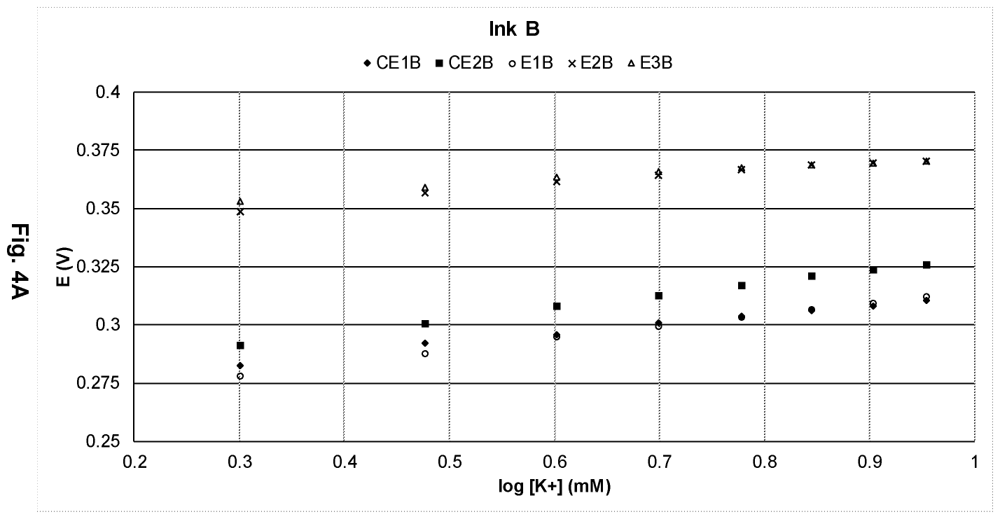

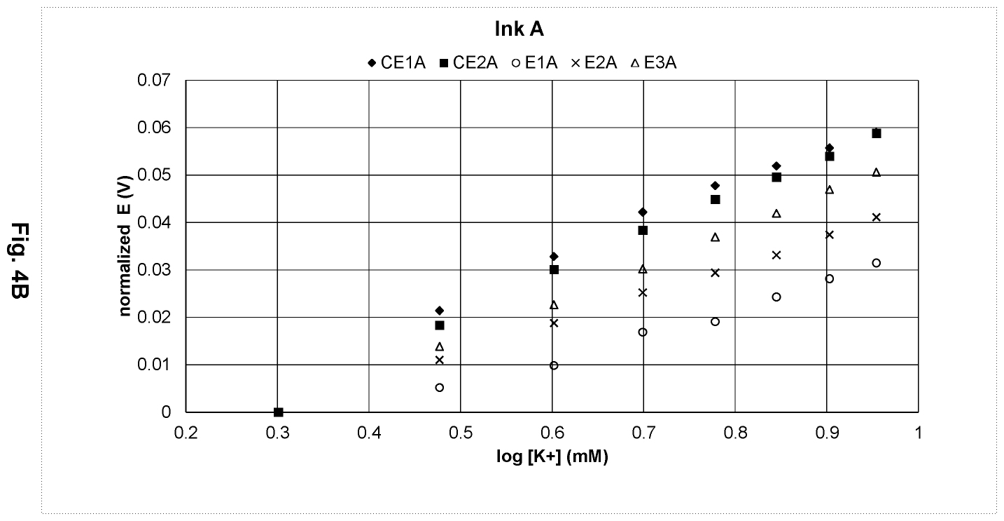

FIGS. 4A and 4B shows graphs of measured OCPs (as measured and normalised, respectively) as a function of log[K⁺] for ion-selective electrode cells prepared according to the method of FIG. 1 (E1A, E2A and E3A) and for comparative ion-selective electrode cells (CE1A and CE2A), using ink A. Normalised OCPs are normalised against the measured OCP for log[K⁺]=0.3. The ion-selective electrode cells prepared according to the method of FIG. 1 (E1A, E2A and E3A) were prepared in situ upon immersing in an aqueous solution at a concentration of K⁺ [K⁺] of 2 mM. The OCPs were measured thereafter and subsequently, the concentration of K⁺ [K⁺] increased successively, while stirring, with corresponding measurements of the OCP at each concentration. OCPs for the comparative ion-selective electrode cells (CE1A and CE2A) were similarly measured at the successive concentrations, having been immersed in the solution for a time corresponding to the preparing of FIG. 1 before the first measurement. The comparative ion-selective electrode cells exhibit a greater than Nernstian response, while the ion-selective electrode cells prepared according to the method of FIG. 1 exhibit a relatively more Nernstian response.

TABLE 1
Equations of lines of best fit of type y = mx + c and R²
for graphs of FIG. 4B.

| Ion-selective | | | |
|---|---|---|---|
| electrode cell | m | c | R² |
| CE1A | 0.0886 | 0.0227 | 0.9837 |
| CE2A | 0.0883 | −0.0246 | 0.9958 |
| E1A | 0.0776 | −0.0235 | 0.9996 |
| E2A | 0.0621 | −0.0186 | 0.9992 |
| E3A | 0.0492 | −0.0173 | 0.9754 |

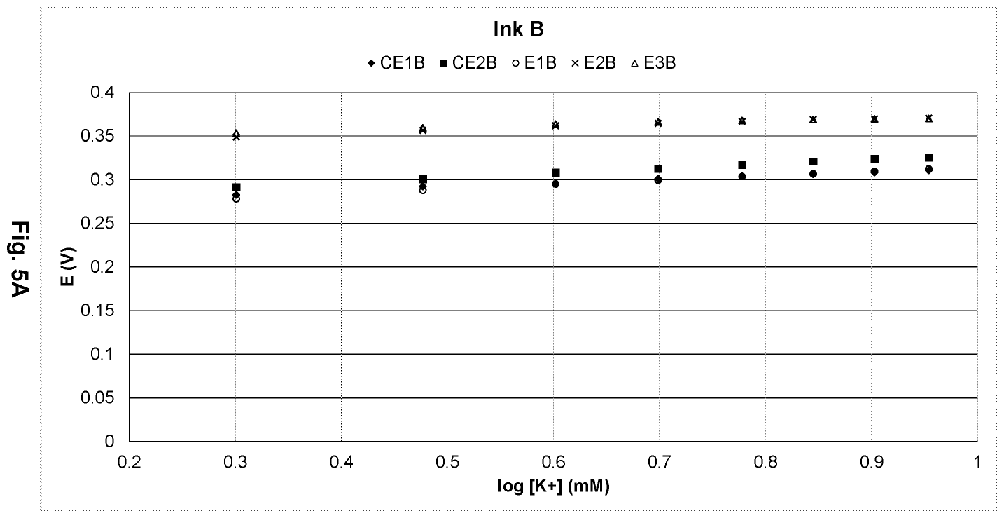

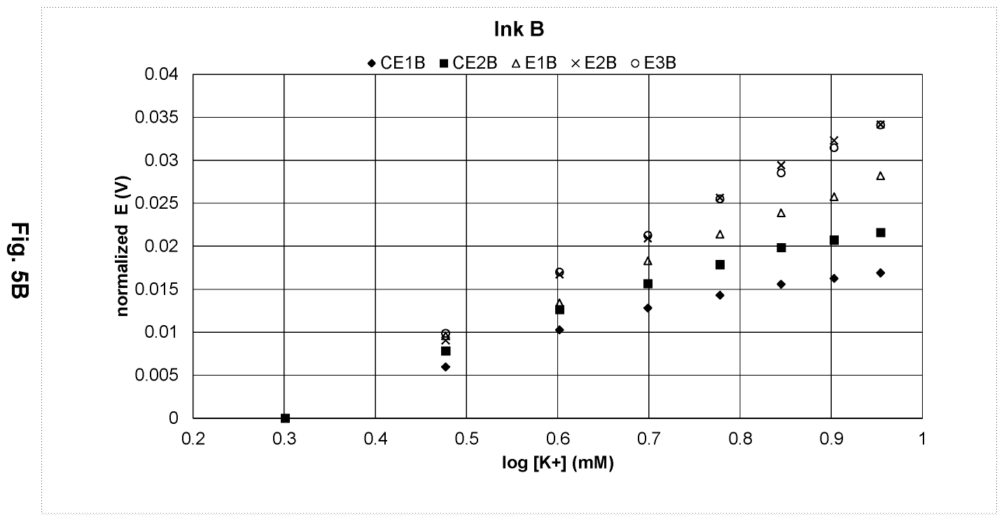

FIGS. 5A and 5B shows graphs of measured OCPs (as measured and normalised, respectively) as a function of log[K⁺] for ion-selective electrode cells prepared according to the method of FIG. 1 (E1B, E2B and E3B) and for comparative ion-selective electrode cells (CE1B and CE2B), using ink B. Normalised OCPs are normalised against the measured OCP for log[K⁺]=0.3. The ion-selective electrode cells prepared according to the method of FIG. 1 (E1B, E2B and E3B) were prepared in situ upon immersing in an aqueous solution at a concentration of K⁺ [K⁺] of 2 mM. The OCPs were measured thereafter and subsequently, the concentration of K⁺ [K⁺] increased successively, while stirring, with corresponding measurements of the OCP at each concentration. OCPs for the comparative ion-selective electrode cells (CE1B and CE2B) were similarly measured at the successive concentrations, having been immersed in the solution for a time corresponding to the preparing of FIG. 1 before the first measurement. The comparative ion-selective electrode cells exhibit a less than Nernstian response, while the ion-selective electrode cells prepared according to the method of FIG. 1 exhibit a relatively more Nernstian response.

TABLE 2
Equations of lines of best fit of type y = mx + c and R²
for graphs of FIG. 5B.

| Ion-selective | | | |
|---|---|---|---|
| electrode cell | m | c | R² |
| CE1B | 0.0259 | −0.0065 | 0.9707 |
| CE2B | 0.0329 | −0.0084 | 0.9791 |
| E1B | 0.0421 | −0.0117 | 0.9947 |
| E2B | 0.0532 | −0.016 | 0.9987 |
| E3B | 0.0517 | −0.0149 | 0.9986 |

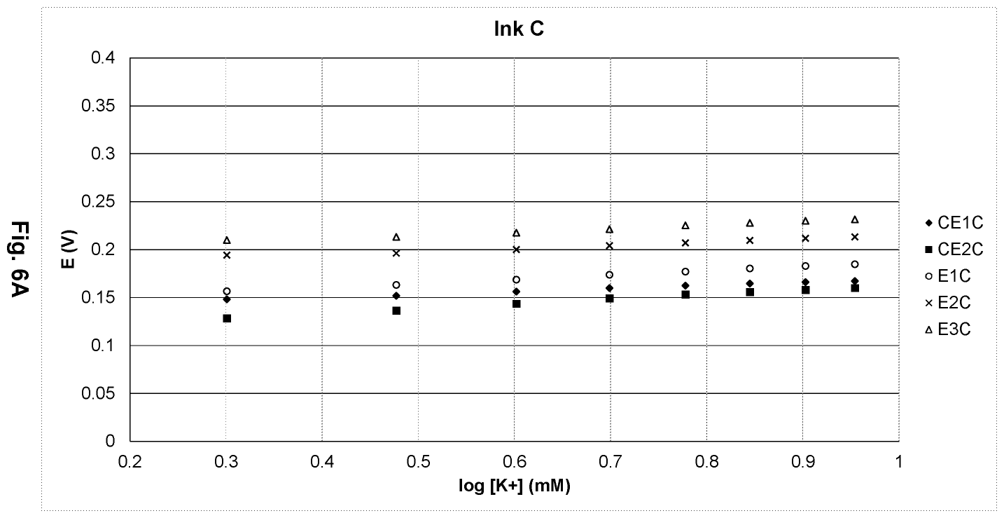

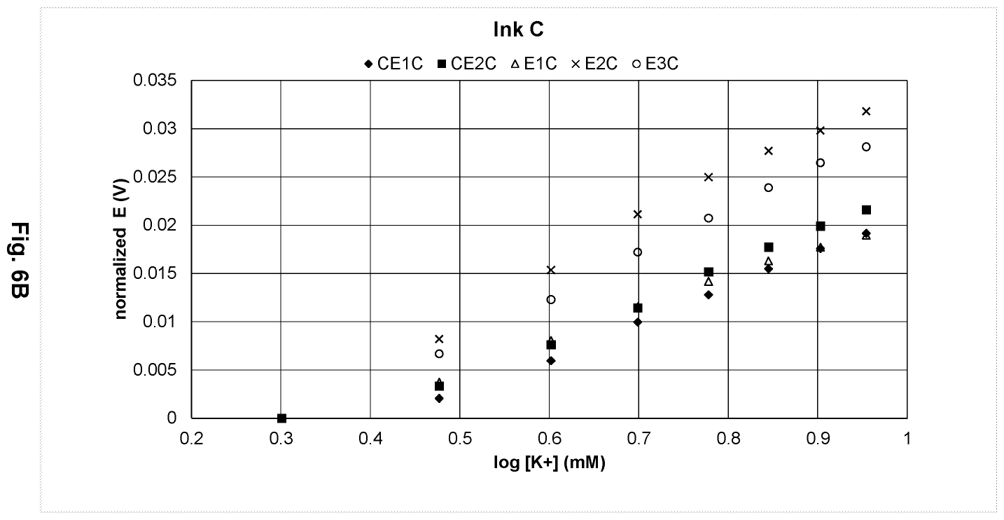

FIGS. 6A and 6B shows graphs of measured OCPs (as measured and normalised, respectively) as a function of log[K⁺] for ion-selective electrode cells prepared according to the method of FIG. 1 (E1C, E2C and E3C) and for comparative ion-selective electrode cells (CE1C and CE2C), using ink C. Normalised OCPs are normalised against the measured OCP for log[K⁺]=0.3. The ion-selective electrode cells prepared according to the method of FIG. 1 (E1C, E2C and E3C) were prepared in situ upon immersing in an aqueous solution at a concentration of K⁺ [K⁺] of 2 mM. The OCPs were measured thereafter and subsequently, the concentration of K⁺ [K⁺] increased successively, while stirring, with corresponding measurements of the OCP at each concentration. OCPs for the comparative ion-selective electrode cells (CE1C and CE2C) were similarly measured at the successive concentrations, having been immersed in the solution for a time corresponding to the preparing of FIG. 1 before the first measurement. The comparative ion-selective electrode cells exhibit a less than Nernstian response, while the ion-selective electrode cells prepared according to the method of FIG. 1 exhibit a relatively more Nernstian response.

TABLE 3
Equations of lines of best fit of type y = mx + c and R²
for graphs of FIG. 6B.

| Ion-selective | | | |
|---|---|---|---|
| electrode cell | m | c | R² |
| CE1C | 0.0315 | −0.0115 | 0.9724 |
| CE2C | 0.0349 | −0.0122 | 0.984 |
| E1C | 0.0305 | −0.0099 | 0.9942 |
| E2C | 0.05 | −0.0149 | 0.9954 |
| E3C | 0.0444 | −0.0139 | 0.9982 |

Particularly, FIGS. 4 to 6 are for the three different commercially available carbon inks. The example ion-selective electrode cells, prepared as described above, exhibit improved linearity and more Nernstian responses compared with the comparative example ion-selective electrode cells, as shown in Table 4. While the different carbon inks A, B, C result in different non-Nernstian responses for the comparative example ion-selective electrode cells, preparing the example ion-selective electrode cells as described herein, results in more Nernstian responses. Without wishing to be bound by any theory, it is though that the method of preparing provides ion-selective electrode cells that are relatively more in equilibrium with the solution than the comparative examples.

TABLE 4
R² for example ion-selective electrode cells and
comparative example ion-selective electrode cells.

| | Ink type 1 | | Ink type 2 | | Ink type 3 | |
|---|---|---|---|---|---|---|
| | | Comparative | | Comparative | | Comparative |
| | Example | example | Example | example | Example | example |
| | 0.9996 | 0.9837 | 0.9987 | 0.9791 | 0.9954 | 0.984 |
| | 0.9992 | 0.9958 | 0.9986 | 0.9707 | 0.9982 | 0.972 |
| | 0.9754 | | 0.9947 | | 0.9942 | |
| Avg R² | 0.9914 | 0.9897 | 0.9973 | 0.9749 | 0.9959 | 0.978 |

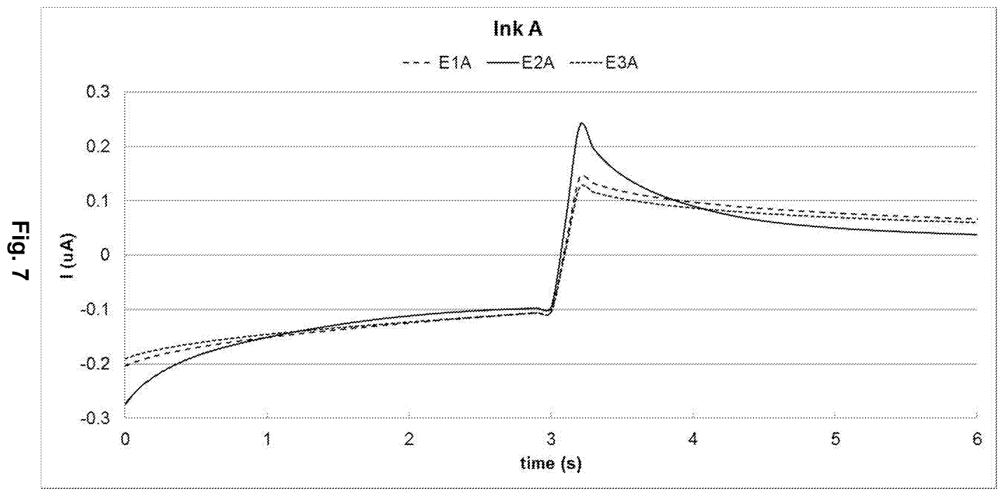

FIG. 7 shows graphs of current measured between the ISE and the CE for ion-selective electrode cells prepared according to the method of FIG. 1.

The current, measured between the ISE and the CE while applying the potential differences, can be used to identify if all electrodes in a batch perform similarly.

For example, example ion-selective electrode cell S2B7 shows a larger current compared to the other two example ion-selective electrode cells. Furthermore, during measurement, example ion-selective electrode cell S2B7 also had the largest potential for the same K⁺ concentration.

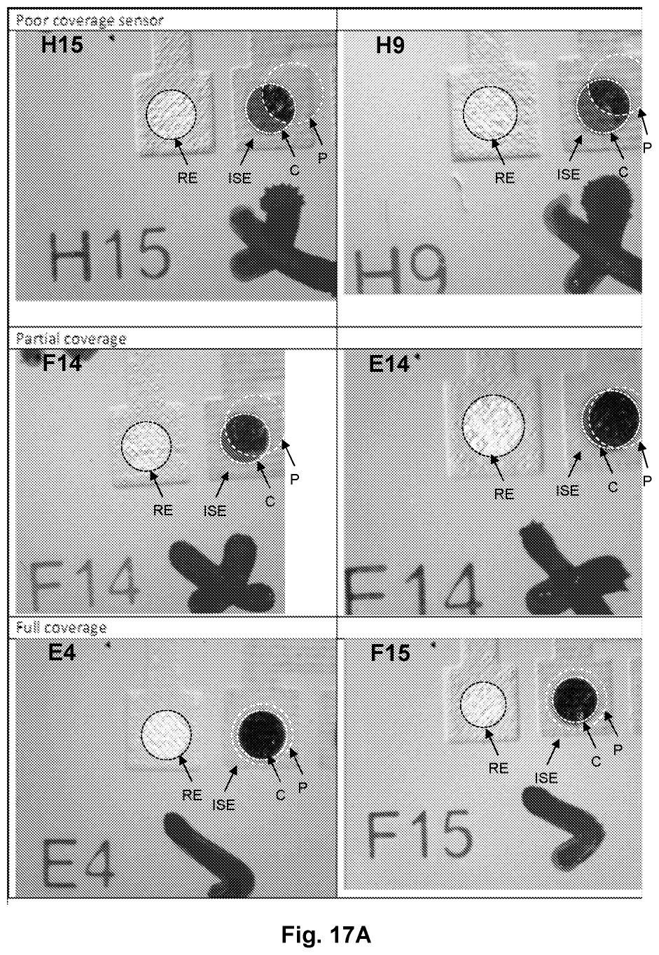

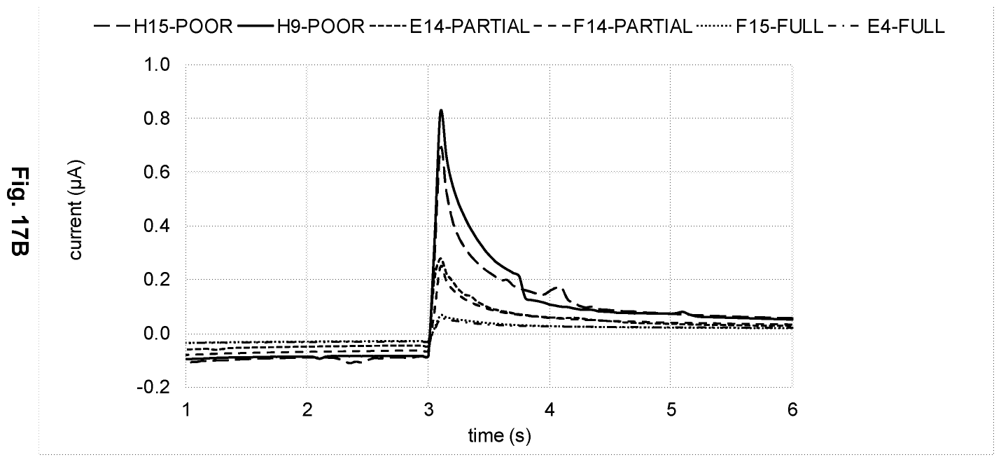

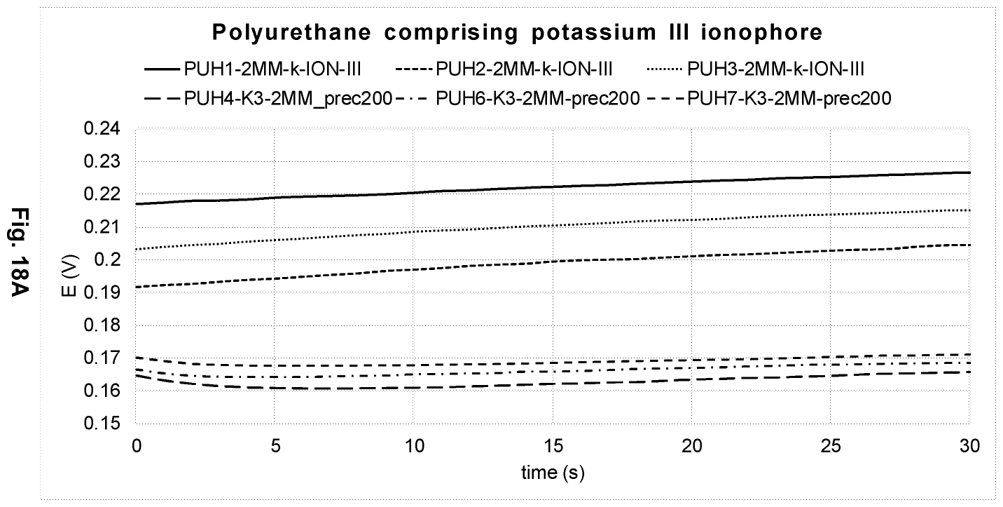

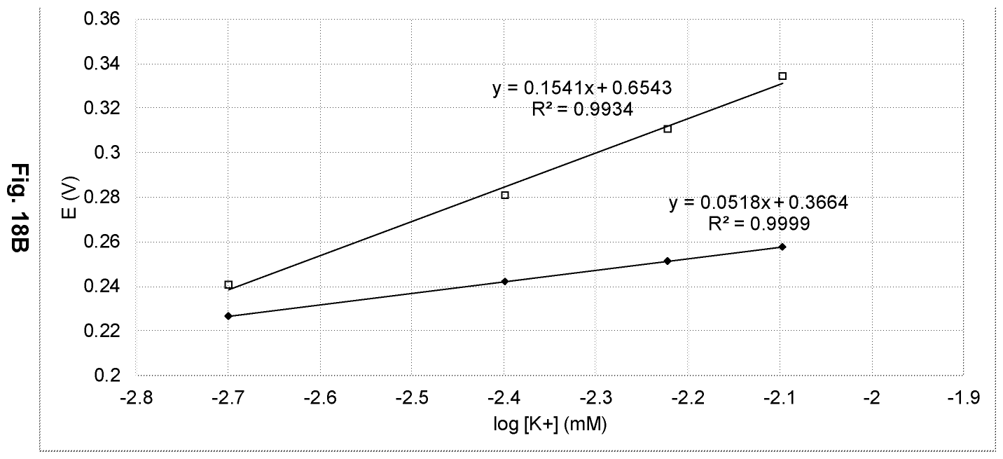

Effect of coverage of carbon by polymer mix FIG. 17A shows photographs of 6 ion-selective electrode cells (H15 and H9; F14 and E14; and E4 and F15) for sensing K⁺ prepared according to the method of FIG. 1. These ISE cells were prepared generally as described with respect to FIG. 2, using Polyvinyl chloride (PVC) 31.3%, bis(2-ethylhexyl) sebacate (DOS) 62.3%, potassium tetrakis(4-chlorophenyl)borate 1.4% and valinomycin 5% in cyclopentanone/propionophenone (3:1) on SPE sensor. In contrast, deposition of the polymer mix was controlled such that: i. H15 and H9: the polymer mix poorly covered the screen printed carbon (about 50% coverage of the carbon); ii. F14 and E14: the polymer mix partially covered the screen printed carbon (about 80% coverage of the carbon); and iii. E4 and F15: the polymer mix completely covered the screen printed carbon (100% coverage of the carbon). For the ion-selective electrode ISE, the perimeter of the of the polymer mix P is shown as a dashed white line and the perimeter of the carbon C is shown as a dotted white line. The perimeter of the Ag reference electrode RE is shown as a black dashed line.

FIG. 17B shows graphs of current measured between the ISE and the CE as a function of time upon changing an applied potential difference from −200 mV to +480 mV at t=3 s for the 6 ion-selective electrodes (H15 and H9; F14 and E14; and E4 and F15) of FIG. 17A. Particularly, FIG. 17B shows that the current spike (i.e. transient current increase) measured when changing the potential difference may be used as an indicator of coverage of the carbon by the polymer mix and hence used for quality control of the ISE cells. For H15 and H9 (poorly covered), a current spike of about 0.8 μA is measured, with the current decaying to a steady-state over about 2 s. For F14 and E14 (partially covered), a current spike of about 0.3 μA is measured, with the current decaying to a steady-state over about 1.5 s. For E4 and F15 (fully covered), a current spike is less than 0.05 μA, with the current decaying to a steady-state over about 0.5 s.

### Use of Polyurethane Comprising Ionophore

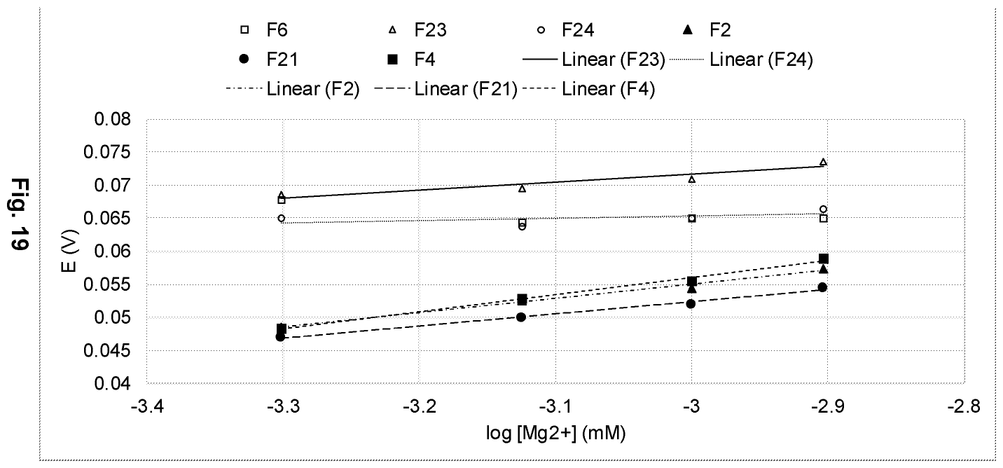

FIG. 18A shows a graph of measured OCP (as measured) as a function of time for ion-selective electrode cells prepared according to the method of FIG. 1 (suffix prec200) and for comparative ion-selective electrode cells. These ISE cells were prepared generally as described with respect to FIG. 2, using PU (Aldrich selectophore), 31.3%, bis(2-ethylhexyl) sebacate (DOS) 62.3%, potassium tetrakis(4-chlorophenyl)borate 1.4% and potassium ionophore III 5% in cyclopentanone/propionophenone (6:1) on SPE sensor. In contrast, the polymer mix included polyurethane (PU) rather than PVC. In addition, during measurement, after a 1 s delay, the potential difference between the ISE and the RE was stepped between −200 mV (hold for 3 s) and +200 mV (hold for 3 s). FIG. 18A shows that the ion-selective electrode cells prepared according to the method of FIG. 1 demonstrate OCP stability over time are reproducible. In contrast, the OCPs for the comparative examples increase continuously over the measurement period and are less reproducible. That is, a time to reach a stable signal is reduced by the exemplary method.

FIG. 18B shows a graph of as measured OCP as a function of log[K⁺] for the exemplary ion-selective electrode cells and for the comparative ion-selective electrode cells of FIG. 18A. The potential difference between the ISE and the RE was stepped between −200 mV (hold for 1 s) and +800 mV (hold for 5 s). Particularly, for the exemplary ion-selective electrode cells (open markers), a super-Nernstian response is observed, with a ×10 change in the activity a_{I} of the K⁺ ion results in a significantly larger change in the electrical potential E, of about 154 mV for the monovalent K⁺ ion. In contrast, this response for the comparative examples is of about 52 mV for a ×10 change in the activity a_{I} of the K⁺ ion. That is, the exemplary method may induce a super-Nernstian response (larger slope of signal vs log_concentration), thereby improving sensitivity, which is important for measuring small differences in concentration. To achieve this, different magnitude of pre-conditioning voltages may be employed, and these voltages may be optimized for each polymer/membrane composition.

Use of Polyurethane Acrylate with Acrylic Monomer Comprising Ionophore

Ion-selective electrode cells and comparative ion-selective electrode cells were prepared according to the method of FIG. 1. These ISE cells were prepared generally as described with respect to FIG. 2, UV curable resin Anycubic, bis(2-ethylhexyl) sebacate, potassium tetrakis(4-chlorophenyl)borate, valinomycin (36.6%, 59.7%, 1.4%, 2.3% w/weight). In contrast, the polymer mix included UV-curable polyurethane acrylate with acrylic monomer rather than PVC.

TABLE 5
R² for example ion-selective electrode cells and comparative example
ion-selective electrode cells. The linearity (R²) for the exemplary ion-
selective electrode cells is improved compared with the comparative
example ion-selective electrode cells.

| | Polyurethane acrylate with acrylic monomer | |
|---|---|---|
| | | Comparative |
| | Example | example |
| | 0.99982 | 0.9967 |
| | 0.99999 | 0.9937 |
| | 0.99994 | 0.9836 |
| Avg R² | 0.99992 | 0.9914 |

### Magnesium

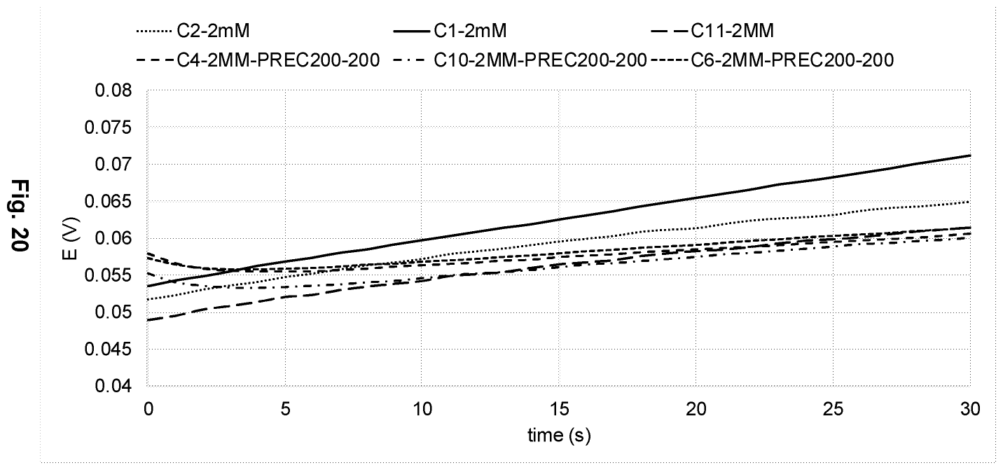

FIG. 19 shows a graph of as measured OCP as a function of log[Mg²⁺ ] for ion-selective electrode cells prepared according to the method of FIG. 1 (F2, F21, F4) and for comparative ion-selective electrode cells (F6, F23, F24). These ISE cells were prepared generally as described with respect to FIG. 2, using PVC, DOS, KTpCIFB, Mg Ionophore I (32.4%, 64.1%, 1.5%, 2% w/weight) in cyclopentanone/propionophenone (4:1) on SPE sensor.

In contrast, the ionophore was Mg Ionophore I rather than valinomycin. The concentration of Mg²⁺ was in the biologically-relevant range of 0.5-1.25 mM.

TABLE 6
R² and gradient for example ion-selective electrode cells and
comparative example ion-selective electrode cells. The exemplary
ISE cells (F2, F21, F4) demonstrate an approximately Nernstian
response (based on gradient), having improved linearity (R²) and
reproducibility, compared with the comparative examples.

| | R² | | Gradient (V) | |
|---|---|---|---|---|
| | | Comparative | | Comparative |
| | Example | example | Example | example |
| | 0.9905 | 0.5720 | 0.0217 | −0.0069 |
| | 0.9896 | 0.8841 | 0.0183 | 0.0119 |
| | 0.9945 | 0.3127 | 0.0258 | 0.0036 |
| Average | 0.9915 | 0.5896 | 0.0219 | 0.0029 |

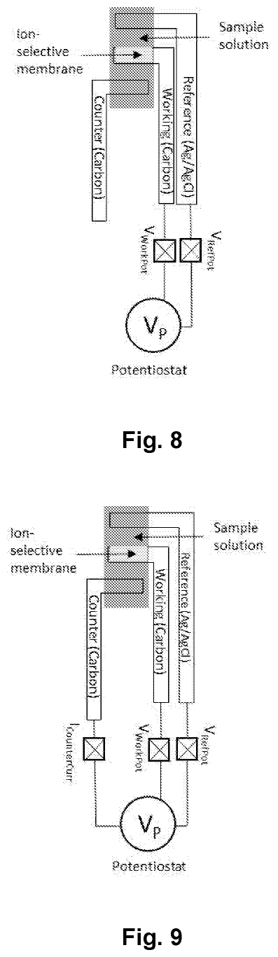

FIG. 20 shows a graph of as measured OCP as a function of time for ion-selective electrode cells prepared according to the method of FIG. 1 (suffix PREC200-200) and for comparative ion-selective electrode cells. These ISE cells were prepared generally as described with respect to FIG. 2, using PVC, NPOE (1-(2-Nitrophenoxy)octane), NaTFBP, Mg Ionophore I (32.8%, 65.7%, 0.5%, 1% w/weight) in cyclopentanone/propionophenone (4:1) on SPE sensor. Particularly, less drift over the measurement duration was observed for the exemplary ISE cells. FIG. 8 schematically depicts an ion-selective electrode cell according to an exemplary embodiment. Particularly, the ion-selective electrode cell comprises the ISE and the RE, as described above, and is depicted in a circuit with a potentiostat. Generally, a potentiostat is electronic hardware required to control a three electrode cell and run most electroanalytical experiments. A bipotentiostat and a polypotentiostat are potentiostats capable of controlling two working electrodes and more than two working electrodes, respectively. The potentiostat functions by maintaining the potential of the working electrode at a constant level with respect to the reference electrode by adjusting the current at an auxiliary electrode. It consists of an electric circuit which is usually described in terms of simple op amps.

FIG. 9 schematically depicts an ion-selective electrode cell according to an exemplary embodiment. Particularly, the ion-selective electrode cell comprises the ISE, the RE and the CE, as described above, and is depicted in a circuit with a potentiostat.

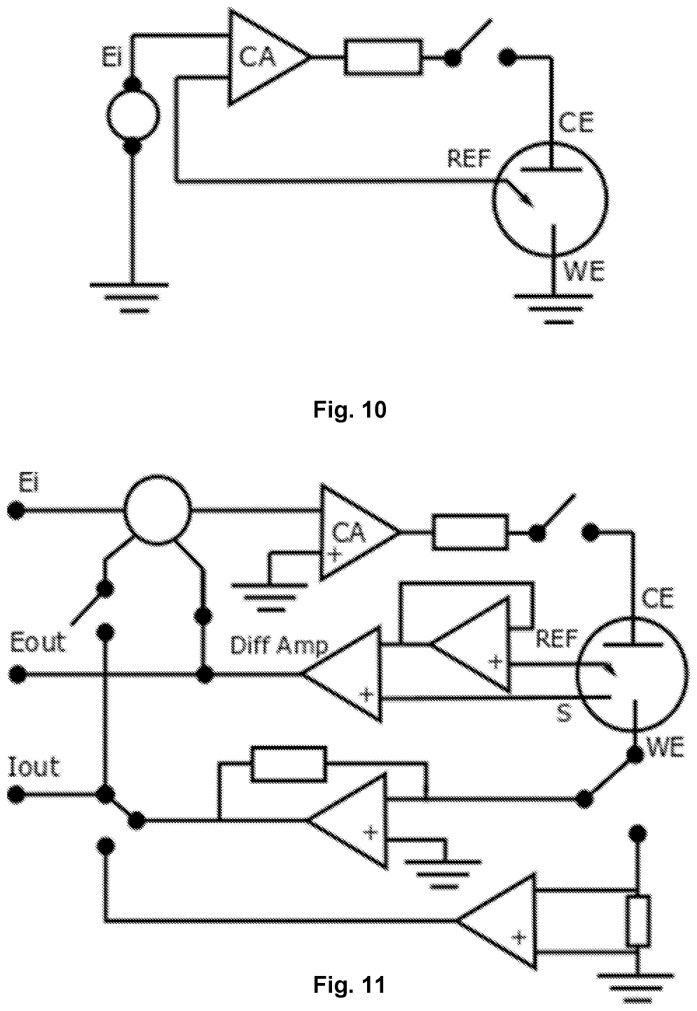

FIG. 10 schematically depicts a circuit for an ion-selective electrode cell according to an exemplary embodiment. Particularly, FIG. 10 shows a potentiostat circuit, for potentiometry.

FIG. 11 schematically depicts a circuit for an ion-selective electrode cell according to an exemplary embodiment. Particularly, FIG. 11 shows a potentiostat/galvanostat circuit, for potentiometry/galvanometry.

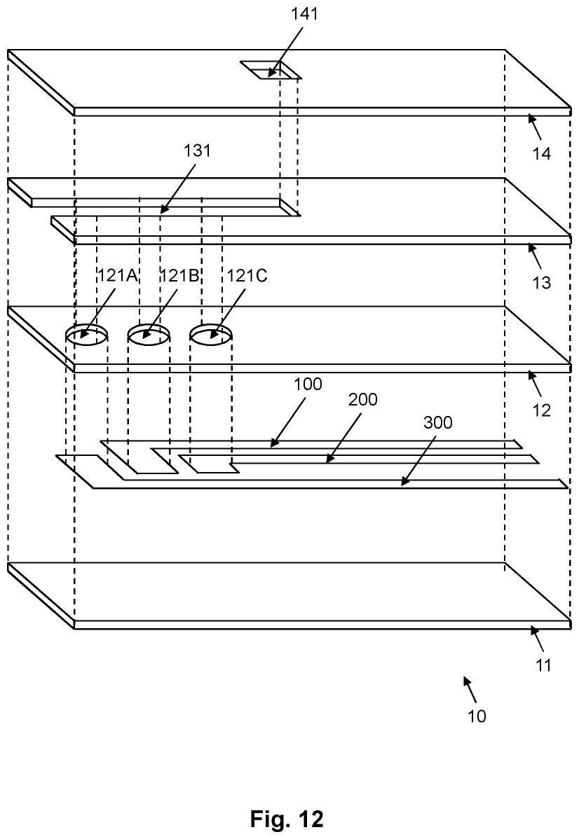

FIG. 12 schematically depicts an exploded, perspective view of an ion-selective electrode cell according to an exemplary embodiment. In this example, the ion-selective electrode cell 10 comprises the ISE 100 and a reference electrode, RE, 200, together with a counter electrode, CE, 300 provided by screen printing on a rectangular substrate layer 11. Each electrode is L-shaped, including a track, provided by the long leg of the L, extending to a first end of the substrate layer 11 for coupling to a potentiostat, for example. Three corresponding circular apertures 121A, 121B, 121C are provided in a mask layer 12 that overlays the ISE 100, the RE 200 and the CE 300, thereby revealing circular portions of these respective electrodes, particularly in the short leg of the respective L. A channel layer 13 overlays the mask layer 12, having therein a channel 131 that extends from a second end of the channel layer 13, distal to the first end of the substrate layer, towards an opposed first end of the channel layer 13, whereby the circular apertures 121A, 121B, 121C are fully within the channel 131. A cover layer 14 overlays the channel layer 13 and includes a square aperture 141 coincident with the end of the channel 131.

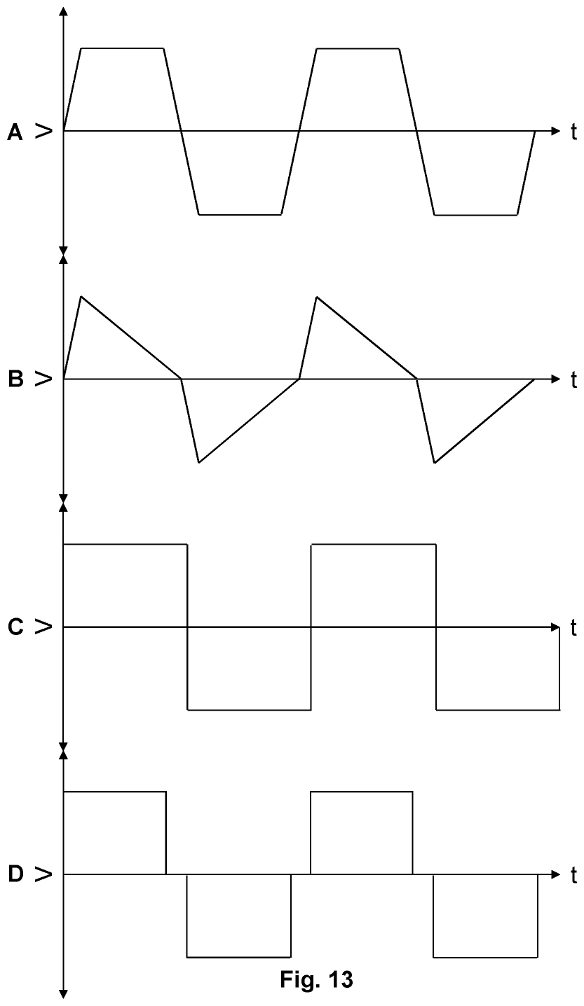

FIG. 13 schematically depicts examples of applying potential differences for the method of FIG. 1, in more detail. In example A, equal and opposite constant potential differences are applied alternately, where M=N=2, with linear ramps therebetween. In example B, equal and opposite triangular waveform potential differences are applied alternately, where M=N=2, with linear ramps therebetween. In example B, equal and opposite rectangular waveform potential differences are applied alternately, where M=N=2, with square ramps therebetween. In example B, equal and opposite rectangular waveform potential differences are applied alternately, where M=N=2, with square ramps and gaps therebetween. As described previously, the first PD of the first set of PDs may comprise a part of, for example a positive part or a negative part, of a waveform, for example an uni-directional, a bi-directional, a periodic, a non-periodic, a symmetrical, a non-symmetrical, a simple and/or a complex waveform such as a sine waveform, a rectangular waveform, a square waveform, a pulse waveform, a ramp waveform, a sawtooth waveform and/or a triangular waveform. Other waveforms are known. In one example, the first set of PDs includes M PDs including the first PD, wherein M is a natural number of at least 1, for example 1, 2, 3, 4, 5, 6, 7, 8, 9, 10, 15, 20, 25, 30, 35, 40, 45, 50, 60, 70, 80, 90, 100, 200, 300, 400, 500, 600, 700, 800, 900, 1000 or more. The M PDs of the first set of PDs may be as described with respect to the first PD of the first set of PDs. Alternatively, the M PDs of the first set of PDs may have mutually different magnitudes and/or durations. The first PD of the second set of PDs and/or the second set of PDs may be as described with respect to the first PD of the first set of PDs and the first set of PDs, respectively. Delays between the PDs of the first set of PDs and the PDs of the second set of PDs may be as described previously.

### Potentiostat

A potentiostat is an electronic instrument that controls the voltage between two electrodes.

### Two Electrode Configurations

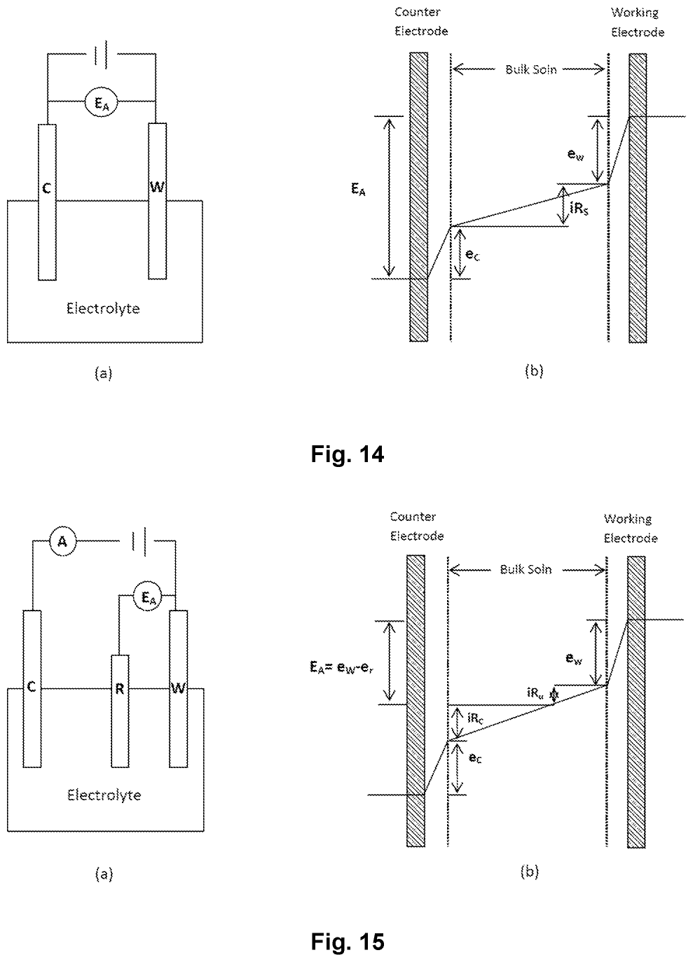

FIG. 14A schematically depicts a circuit for an ion-selective electrode cell according to an exemplary embodiment; and FIG. 14B schematically depicts potential gradients in the ion-selective electrode cell of FIG. 14A. Particularly, FIG. 14A schematically depicts a two electrode configuration where EA is the applied voltage and C and W are the counter and working electrodes respectively; and FIG. 14B schematically depicts potential gradients in the two electrode system while current is flowing.

This configuration includes a Working Electrode (WE) where the chemistry of interest occurs and a Counter Electrode (CE) which acts as the other half of the cell. The applied potential (EA) is measured between the working and counter electrode and the resulting current is measured in the working or counter electrode lead.

The CE in the two-electrode set-up serves two functions. It completes the circuit allowing charge to flow through the cell, and it also maintains a constant interfacial potential, regardless of current. Fulfilling both of these requirements is an impossible task under most conditions. In a two-electrode system, it is very difficult to maintain a constant CE potential (eC) while current is flowing. This fact, along with a lack of compensation for the voltage drop across the solution (iRS) leads to poor control of the WE potential (eW) with a two-electrode system. The roles of passing current and maintaining a reference voltage are better served by two separate electrodes.

### Three-Electrode Configuration

FIG. 15A schematically depicts a circuit for an ion-selective electrode cell according to an exemplary embodiment; and FIG. 15B schematically depicts potential gradients in the ion-selective electrode cell of FIG. 15A. Particularly, FIG. 15A schematically depicts a three-electrode configuration where EA is the applied voltage and W, C and R are the working, counter and reference electrodes respectively; and FIG. 15B schematically depicts potential gradients in the three-electrode system while current is flowing.

The three-electrode system remedies many of the issues of the two-electrode configuration. The three-electrode system consists of a working electrode, counter electrode, and reference electrode. The reference electrode's role is to act as a reference in measuring and controlling the working electrode potential, without passing any current. The reference electrode should have a constant electrochemical potential at low current density. Additionally, since the reference electrode passes negligible current, the iR drop between the reference and working electrode (iRU) is often very small. Thus with the three-electrode system, the reference potential is much more stable, and there is compensation for iR drop across the solution. This translates into superior control over working electrode potential. The most common lab reference electrodes are the Saturated Calomel Electrode and the Ag/AgCl electrode.

In the three-electrode configuration, the only role of the counter electrode is to pass all the current needed to balance the current observed at the working electrode. The counter electrode will often swing to extreme potentials in order to accomplish this task.

### Potentiostat Operation

A basic potentiostat can be modelled as an electronic circuit including four components: the electrometer, the I/E converter, the control amplifier, and the signal.

### The Electrometer

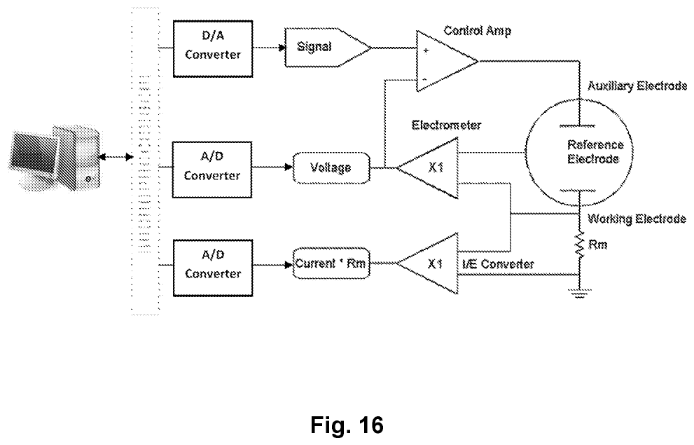

FIG. 16 schematically depicts a circuit for an ion-selective electrode cell according to an exemplary embodiment. Particularly, FIG. 16 shows a block diagram of a typical computer controlled potentiostat system for a three electrode controlled potential apparatus. X1 on an amplifier indicates a unity gain amplifier.

The electrometer circuit measures the voltage difference between the working and the reference electrode. The output serves two purposes: it acts as a feedback signal within the potentiostat, and I is the voltage signal that is measured and displayed to the user.

An ideal electrometer has infinite impendence and zero current. In reality the reference electrode does pass a very small amount of current. Current through the reference electrode can change its potential, but this current is usually so close to zero that the change is negligible.

The capacitance of the electrometer and the resistance of the reference electrode form an RC circuit. If the RC time constant is too large it can limit the effective bandwidth of the electrometer.

The electrometer bandwidth must be higher than the bandwidth of all other components in the potentiostat.

### The I/E Converter

The current to voltage converter measures the cell current. The cell current is forced through a current measurement resistor, Rm. The resulting voltage across this resistor is a measure of cell current.

During the course of an experiment, cell current can change by several orders of magnitude. Such a wide range of current cannot be accurately measured by a single resistor. Modern potentiostats have a number of Rm resistors and an “I/E autoranging” algorithm that selects the appropriate resistor and switches it into the I/E circuit under computer control.

The bandwidth of the I/E converter depends strongly on its sensitivity. Unwanted capacitance in the I/E converter along with Rm forms an RC circuit. In order to measure small currents, Rm must be sufficiently large. This larger resistance, however, increases the RC time constant of the circuit limits the I/E bandwidth. For instance, no potentiostat can measure 10 nA at 100 kHz.

### The Control Amplifier

The control amplifier compares the measured cell voltage to the desired cell voltage and drives current into the cell to force these voltages to be the same. The control amplifier works on the principle of negative feedback. The measured voltage enters the amplifier in the negative or inverting input. Therefore a positive perturbation in the measured voltage creates a decrease in the control amplifier output, which counteracts the initial change. The control amplifier has a limited output capability, for the Emstat this is 3 V and 10 mA.

### The Signal

In modern potentiostats, the signal circuit is a computer controlled voltage source. Proper choice of number sequences allows the computer to generate constant voltages, voltage ramps and sine waves at the signal current output.

### Computer Controlled Instrumentation

Most potentiostats now utilize a microprocessor for signal generation and data acquisition. Computers are very useful for generating complex voltage waveforms. These waveforms are first created as numerical arrays in memory, which are sent to a Digital to Analog Converter (DAC). The DAC produces an analog voltage proportional to the digital numerical arrays. The analog voltage is then sent to the control amplifier of the potentiostat.

Conversely, in data acquisition, the voltage responses from the electrometer and I/E converter are digitized into numerical arrays and recorded at fixed time intervals. The accuracy of the analog to digital conversion depends on the number of bits used for a given voltage signal. For instance, if a measurement system digitizes a 0-10 V input signal with 8 bit resolution, it transforms the voltage signal to a number in the range 0-255 according to a binary conversion. Hence, after digitization, a 0 to 10 V signal expressed as an 8-bit array will have a resolution of 10/255 or 39.2 mV.

Although a preferred embodiment has been shown and described, it will be appreciated by those skilled in the art that various changes and modifications might be made without departing from the scope of the invention, as defined in the appended claims and as described above.

In summary, the invention provides an ion-selective electrode cell for an ion selective electrode and a method of preparing an ion-selective electrode, ISE, for an ion-selective electrode cell for an ion selective electrode.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims and drawings), and/or all of the steps of any method or process so disclosed, may be combined in any combination, except combinations where at most some of such features and/or steps are mutually exclusive.

Each feature disclosed in this specification (including any accompanying claims, and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims and drawings), or to any novel one, or any novel combination, of the steps of any method or process so disclosed.

1-16. (canceled)

17. A method of preparing an ion-selective electrode, ISE, for an ion-selective electrode cell, the ion-selective electrode cell comprising the ISE and a reference electrode, RE, the method comprising steps of:
exposing the ISE and a second electrode to a solution including the ion;
applying a first potential difference, PD, of a first set of PDs, having a polarity, across the ISE and the second electrode; and
applying a first potential difference, PD, of a second set of PDs, having a reverse polarity, across the ISE and the second electrode.

18. The method according to claim 17, wherein:
applying the first PD of the second set of PDs comprises applying the first PD of the second set of PDs within a period after applying the first PD of the first set of PDs, and
the period is in a range from 0 ms to 100 s, 1 μs to 100 s, 10 μs to 100 s, 100 μs to 100 s, or 1 ms to 100 s.

19. The method according to claim 17, wherein the period is in a range of either:
one of from 1 μs to 10 s, 10 μs to 10 s, 100 μs to 10 s, 1 ms to 10 s, or 100 ms to 10 s; or
one of from 1 μs to 5 s, 10 μs to 5 s, 100 μs to 5 s, 1 ms to 5 s, 10 ms to 5 s, 100 ms to 5 s, or 1 s to 5 s; or
20 ms.

20. The method according to claim 17, wherein applying the first PD of the first set of PDs and/or the first PD of the second set of PDs comprises, at least in part, initiating ion flux at least one of into or out of the ISE.

21. The method according to claim 17, wherein applying the first PD of the first set of PDs and/or the first PD of the second set of PDs comprises applying the first PD of the first set of PDs having a magnitude of at most a damage threshold of the ISE.

22. The method according to claim 17, wherein applying the first PD of the second set of PDs and/or the first PD of the first set of PDs comprises removing, at least in part, excess surface charge of the ISE.

23. The method according to claim 17, wherein at least one of:
applying the first PD of the first set of PDs comprises applying the first PD of the first set of PDs for a first duration in a range from 1 ms to 100 s; or
applying the first PD of the second set of PDs comprises applying the first PD of the second set of PDs for a second duration in a range from 1 ms to 100 s.

24. The method according to claim 17, wherein:
the first duration is in a range from 100 ms to 10 s or from 1 s to 5 s; and
the second duration is in a range from 100 ms to 10 s or from 1 s to 5 s.

25. The method according to claim 17, wherein the first set of PDs includes M PDs including the first PD thereof and/or wherein the second set of PDs includes N PDs including the first PD thereof, wherein M and N are natural numbers of at least 1 and wherein M+N is greater than or equal to 3, wherein the method comprises alternately applying at least one of the PDs of the first set of PDs and applying at least one PD of the second set of PDs.

26. The method according to claim 17, wherein the first PD of the first set of PDs is constant and/or the first PD of the second set of PDs is constant.

27. The method according to claim 17, wherein the ion-selective electrode cell comprises counter electrode, CE, and wherein the method comprises measuring a current between the ISE and CE while applying the first PD of the first set of PDs and/or while applying the first PD of the second set of PDs.

28. The method according to claim 17, wherein the ISE comprises an ion-selective coating.

29. The method according to claim 17, wherein the second electrode comprises and/or is a counter electrode, CE.

30. A method of determining a presence of an ion in a solution using an ion-selective electrode cell comprising an ion-selective electrode, ISE, and a reference electrode, RE, the method comprising steps of:
preparing the ISE according to claim 17 using the solution; and
determining the presence of the ion in the solution, for example potentiometrically, galvanometrically and/or by impedance, using the ion-selective electrode cell including the prepared ISE,
wherein optionally the determining step occurs within 300 s of completing the preparing step.

31. An ion-selective electrode, ISE, prepared according to claim 17.

32. An ion-selective electrode cell comprising an ion-selective electrode, ISE, according to claim 31.

33. A device for preparing an ion-selective electrode, ISE, for an ion-selective electrode cell, the ion-selective electrode cell comprising the ISE and a reference electrode, RE, wherein the device is configured to:
apply a first potential difference, PD, of a first set of PDs, having a polarity, across the ISE and a second electrode; and
apply a first potential difference, PD, of a second set of PDs, having a reverse polarity, across the ISE and the second electrode.

34. The device of claim 33, wherein:
the device is configured to apply the first PD of the second set of PDs within a period after applying the first PD of the first set of PDs, and
the period is one of:
in a range from 0 ms to 100 s, 1 μs to 10 μs, 10 μs to 100 s, 100 μs to 100 s, or 1 ms to 100 s,
in a range from 1 μs to 10 s, 10 μs to 10 s, 100 μs to 10 s, 1 ms to 10 s, or 100 ms to 10 s,
in a range from 1 μs to 5 s, 10 μs to 5 s, 100 μs to 5 s, 1 ms to 5 s, 10 ms to 5 s, 100 ms to 5 s, or 1 s to 5 s, or 20 ms.

35. An ion-selective electrode cell assembly comprising:
an ion-selective electrode cell comprising an ion-selective electrode, ISE, and a reference electrode, RE; and
the device according to claim 33.

36. Use of in situ reversed polarities to condition an ion selective electrode, ISE, for determining a presence of an ion in a solution.
